(19) United States
(12) Patent Application Publication
(10) Pub. No.: US 2014/0025372 A1
(43) Pub. Date: Jan. 23, 2014

(54) TEXT ANALYZING DEVICE, PROBLEMATIC BEHAVIOR EXTRACTION METHOD, AND PROBLEMATIC BEHAVIOR EXTRACTION PROGRAM

(71) Applicants: Akihiro Tamura, Tokyo (JP); Kai Ishikawa, Tokyo (JP)

(72) Inventors: Akihiro Tamura, Tokyo (JP); Kai Ishikawa, Tokyo (JP)

(73) Assignee: NEC CORPORATION, Minato-ku, Tokyo (JP)

(21) Appl. No.: 14/008,364

(22) PCT Filed: Mar. 26, 2012
(86) PCT No.: PCT/JP2012/002075

§ 371 Date: Sep. 27, 2013

(30) Foreign Application Priority Data
Mar. 28, 2011 (JP) 2011-070202

(51) Int. Cl. G06F 17/21

(52) U.S. Cl. CPC G06F 17/21
USPC 704/9

(57) ABSTRACT

The present invention provides a text analyzing device which can extract the great amount of problematic behavior at low cost. A punishment action text extraction means 81 extracts a text which describes a punishment action which is an action which indicates a punishment of a fraud or an illegal act, or an action for demanding the punishment, from an input text set which is a set of a plurality of texts to be inputted. A problematic behavior extraction means 82 extracts description related to a problematic behavior which is a cause of the punishment action taken before the punishment action described in the text extracted by the punishment action text extraction means 81.

### TECHNICAL FIELD

The present invention relates to a text analyzing device, a problematic behavior extraction method and a problematic behavior extraction program which analyze a text and extract a fraud and an illegal act described in the text and an action and a remark which predict the fraud and the illegal act.

### BACKGROUND ART

In a bulletin board or a weblog on the Internet, a fraud or an illegal act by a company or a person or an action or a remark which predicts a fraud or an illegality is written by poster in some cases. Hereinafter, an action and a remark is collectively referred to as a “behavior”. Further, hereinafter, a fraud, an illegal act and an action or a remark which predicts a fraud or an illegality are collectively referred to as a “problematic behavior”. For example, that “I got a cold call from company A saying I would absolutely gain profit” is written in a bulletin board. In this case, an action of this company A is a problematic behavior which is misstatement and which violates a law related to Act on Specified Commercial Transactions.

If a related person who is an agent of this problematic behavior or a company to which this agent belongs can find description related to such a problematic behavior, these people can take a countermeasure taken by these people to work on the agent and, for example, improve behavior. Further, a person or an organization that cracks down on a fraud or an illegal act can use description as to a problematic behavior as a material to recognize a fraud or an illegal act, as a clue to make detailed investigation or as an evidence of a fraud or an illegal act.

Hence, there is a system which analyzes a website and detects predetermined content. PLT 1 discloses a device which detects a bulletin board in which content similar to predetermined content is written. The device disclosed in PLT 1 stores a representative vector of a category of content which needs to be detected as category data, and determines the similarity between a vector of the bulletin board and the representative vector of this category. In addition, the category of content which needs to be detected includes, for example, a category of description content related to a crime, a category of description content which slanders an individual and a category of description content which causes a disadvantage to a company. Further, the device disclosed in PLT 1 extracts a bulletin board which needs to be detected based on the determined similarity and monitoring reference data (more specifically, a threshold which indicates the similarity between the bulletin board which needs to be monitored and a predetermined category).

In addition, PLT 2 discloses an analyzing device which analyzes the tense of a Japanese sentence. Further, PLT 3 discloses a topic boundary determination method of dividing video content and audio content into topic units.

Furthermore, NPL 1 discloses a method of automatically extracting knowledge related to causation using a syntax pattern and a cue phrase. NPL 2 discloses data mining of extracting a characteristic element.

### CITATION LIST

### Patent Literature

PLT 1: Japanese Patent Application Laid-Open No. 2010-23147
PLT 2: Japanese Patent Application Laid-Open No. 8-44741
PLT 3: Japanese Patent No. 4175093

### Non-Patent Literature

NPL 1: Hiroki SAKAJI, Kousuke TAKEUCHI, Satoshi SEKINE and Shigeru MASUYAMA, “Extraction of causation using syntax pattern” The Association for Natural Language Processing 14th Convention, pp. 1144-1147, 2008.
NPL 2: Hang Li and Kenji Yamanishi, “Mining from open answers in questionnaire data”, In Proceedings of KDD-01, pp. 443-449, 2001.

### SUMMARY OF INVENTION

### Technical Problem

By using the device disclosed in PLT 1, it is possible to detect description related to a problematic behavior. More specifically, by preparing a set of descriptions related to a problematic behavior in advance as learning data, and using, for example, a SVM (Support Vector Machine) from these items of learning data (more specifically, data includes problematic behavior as a set of positive examples and other behavior as a set of negative examples), a representative vector is created.

However, PLT 1 does not disclose a method of creating a set of descriptions related to a problematic behavior. A set of descriptions related to a problematic behavior may also be manually created as learning data. However, there is an infinite number of behavior corresponding to frauds and illegal acts, and therefore there is a problem that creating the set of descriptions related to a problematic behavior is costly.

In case of, for example, an action of “saying a lie or a thing different from a fact as a behavior corresponding to misstatement as an illegal act”, there is an infinite number of lies and things different from facts. That is, even one problematic behavior corresponding to misstatement may include an infinite number of behavior corresponding to frauds and illegal acts. Thus, to create a representative vector which comprehensively covers an expression of a problematic behavior, a great number of problematic behavior which serve as learning data are required. Hence, there is a problem that manually creating description related to a problematic behavior is enormously costly.

It is therefore an exemplary object of the present invention to provide a text analyzing device, a problematic behavior extraction method and a problematic behavior extraction program which can extract description related to the great amount of problematic behavior at low cost.

### Solution to Problem

A text analyzing device according to the present invention includes: a punishment action text extraction means which extracts a text which describes a punishment action which is an action which indicates a punishment of a fraud or an illegal act, or an action for demanding the punishment, from an input text set which is a set of a plurality of texts to be inputted; and a problematic behavior extraction means which extracts a behavior as a problematic behavior which is a cause of the punishment action taken before the punishment action described in the text extracted by the punishment action text extraction means.

A problematic behavior extraction method according to the present invention includes: extracting a text which describes a punishment action which is an action which indicates a punishment of a fraud or an illegal act, or an action for demanding the punishment, from an input text set which is a set of a plurality of texts to be inputted; and extracting a behavior as a problematic behavior which is a cause of the punishment action taken before the punishment action included in the extracted text.

A problematic behavior extraction program according to the present invention causes a computer to execute: punishment action text extraction processing of extracting a text which describes a punishment action which is an action which indicates a punishment of a fraud or an illegal act, or an action for demanding the punishment, from an input text set which is a set of a plurality of texts to be inputted; and problematic behavior extraction processing of extracting a behavior as a problematic behavior which is a cause of the punishment action taken before the punishment action described in the text extracted by the punishment action text extraction processing.

### Advantageous Effects of Invention

The present invention can extract description related to the great amount of problematic behavior at low cost.

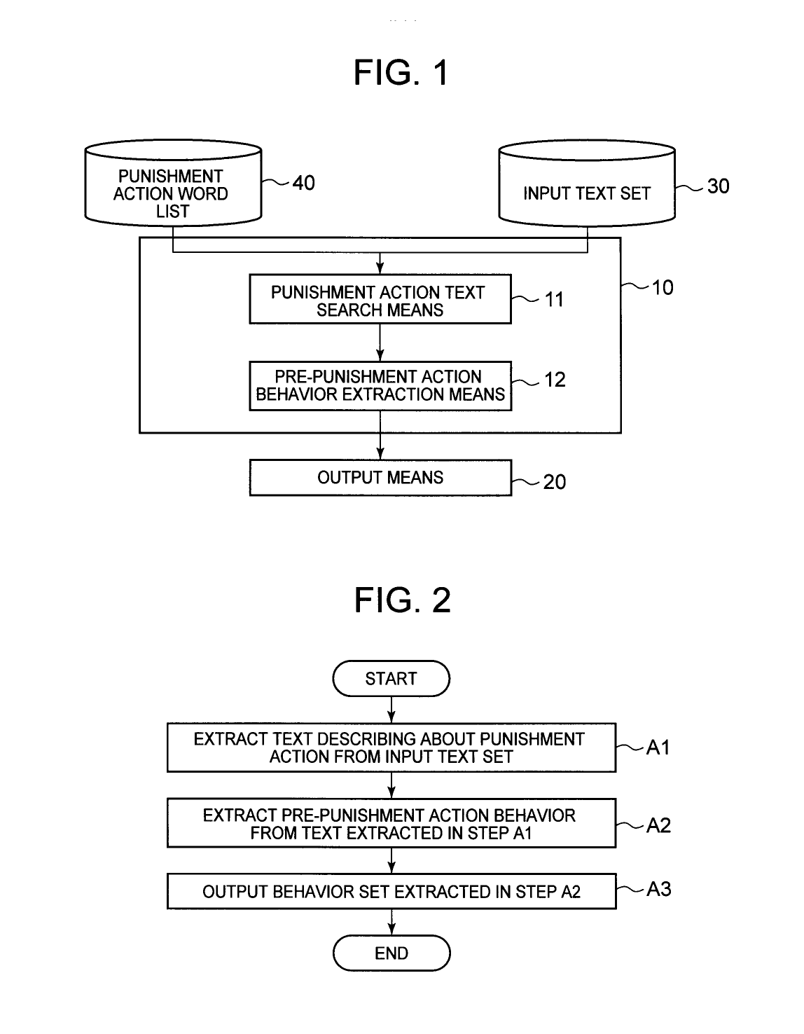

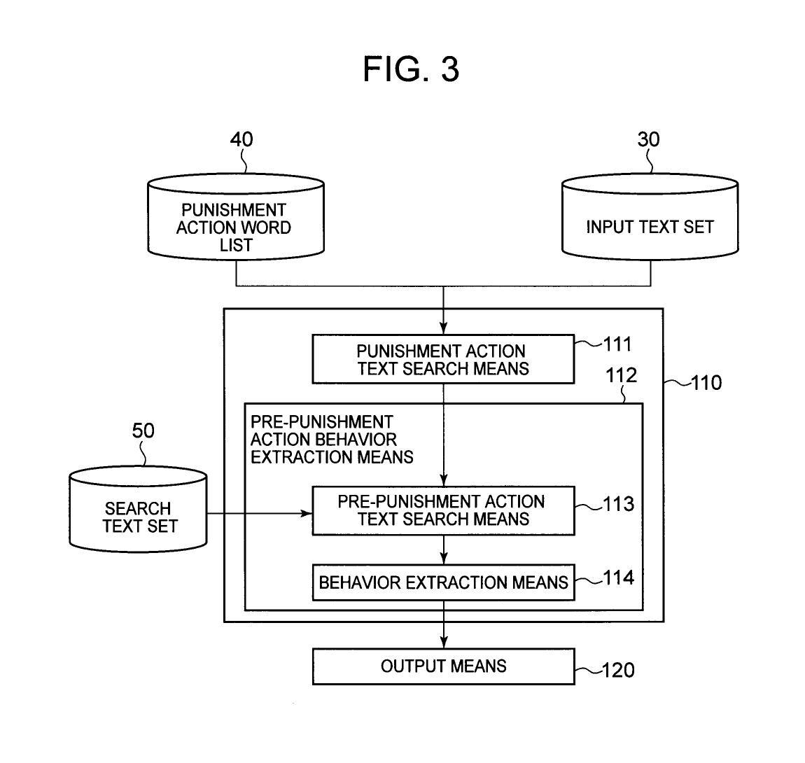

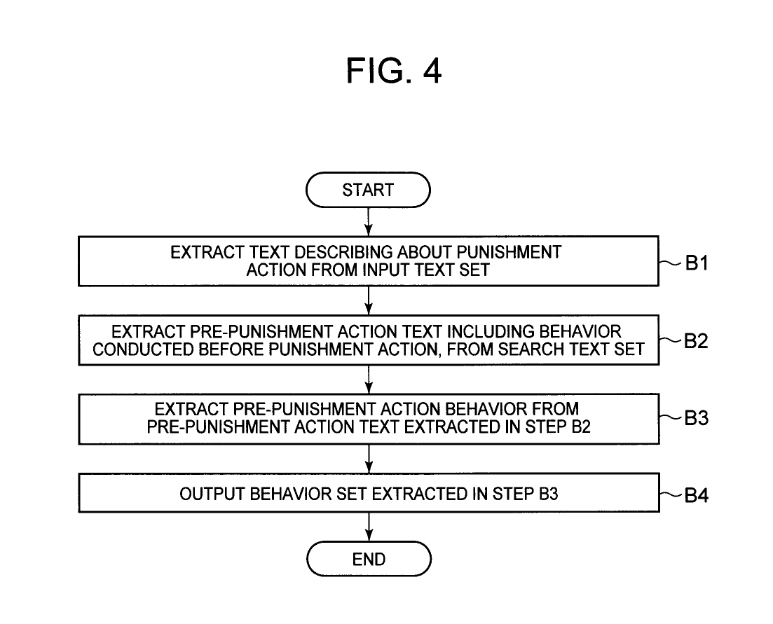

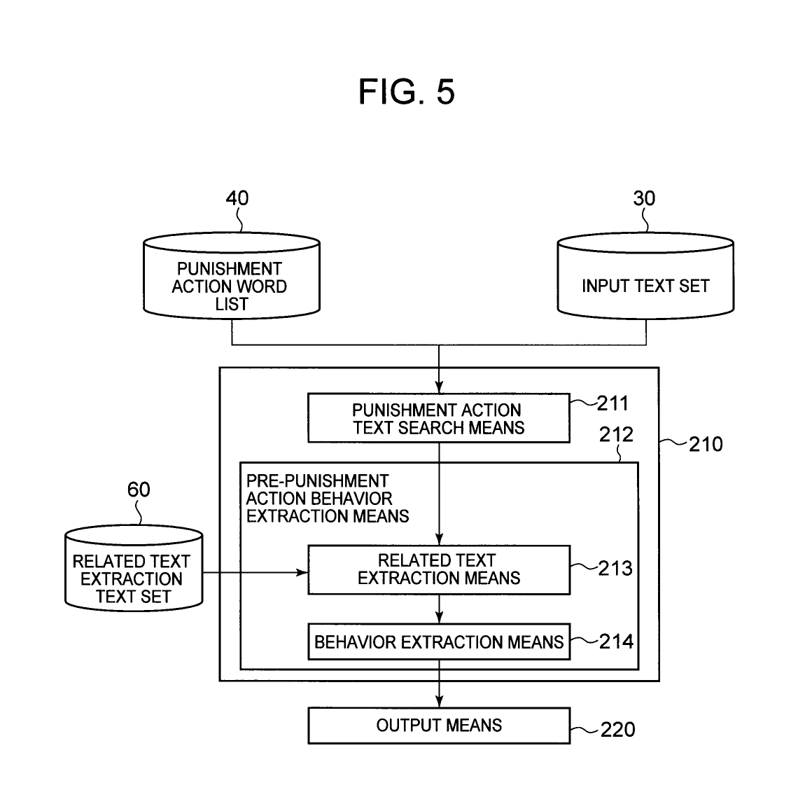

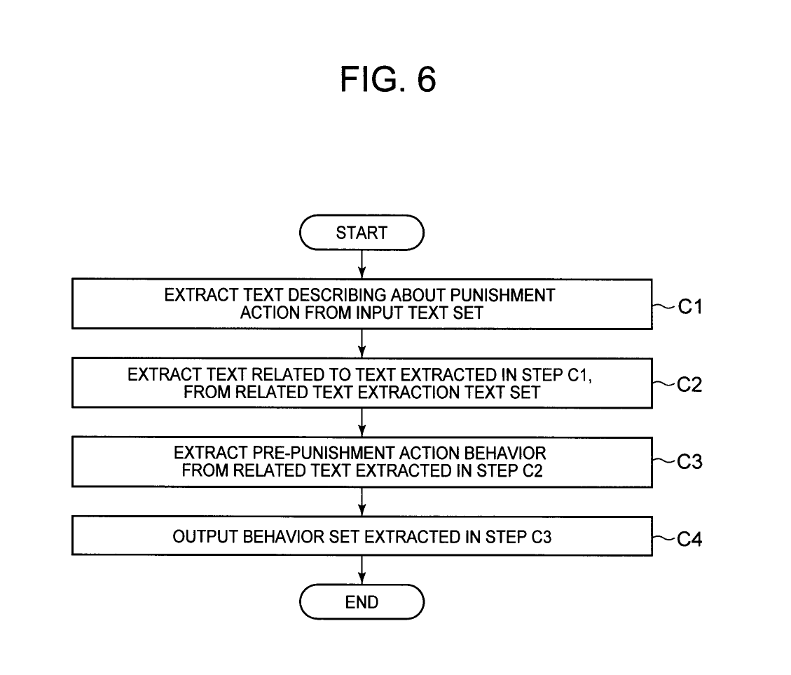

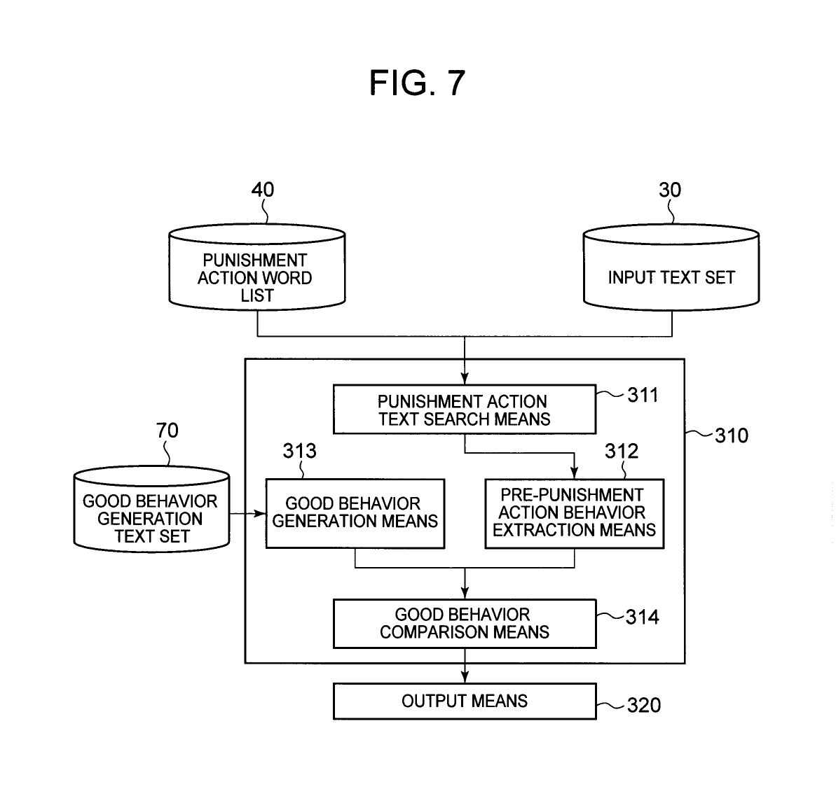

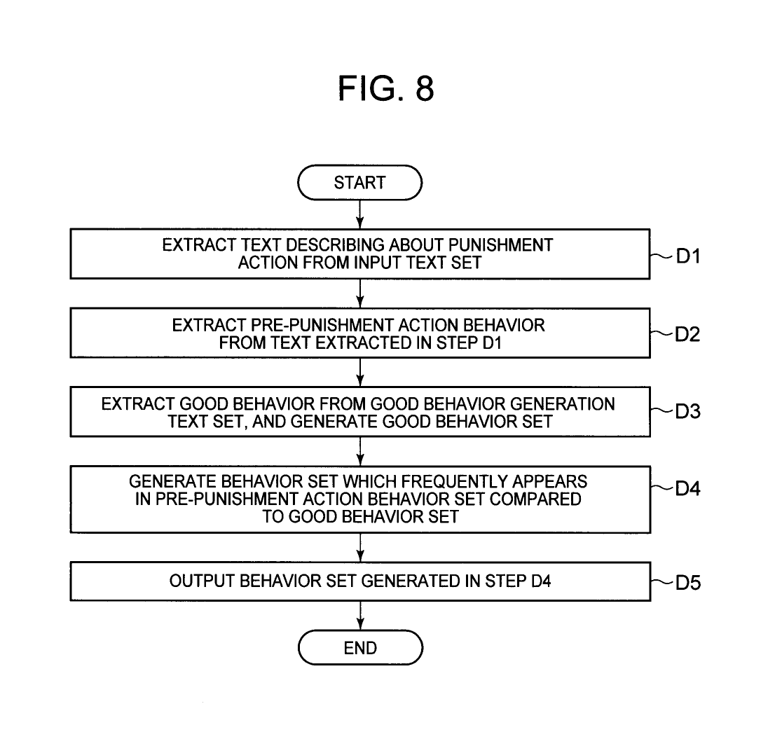

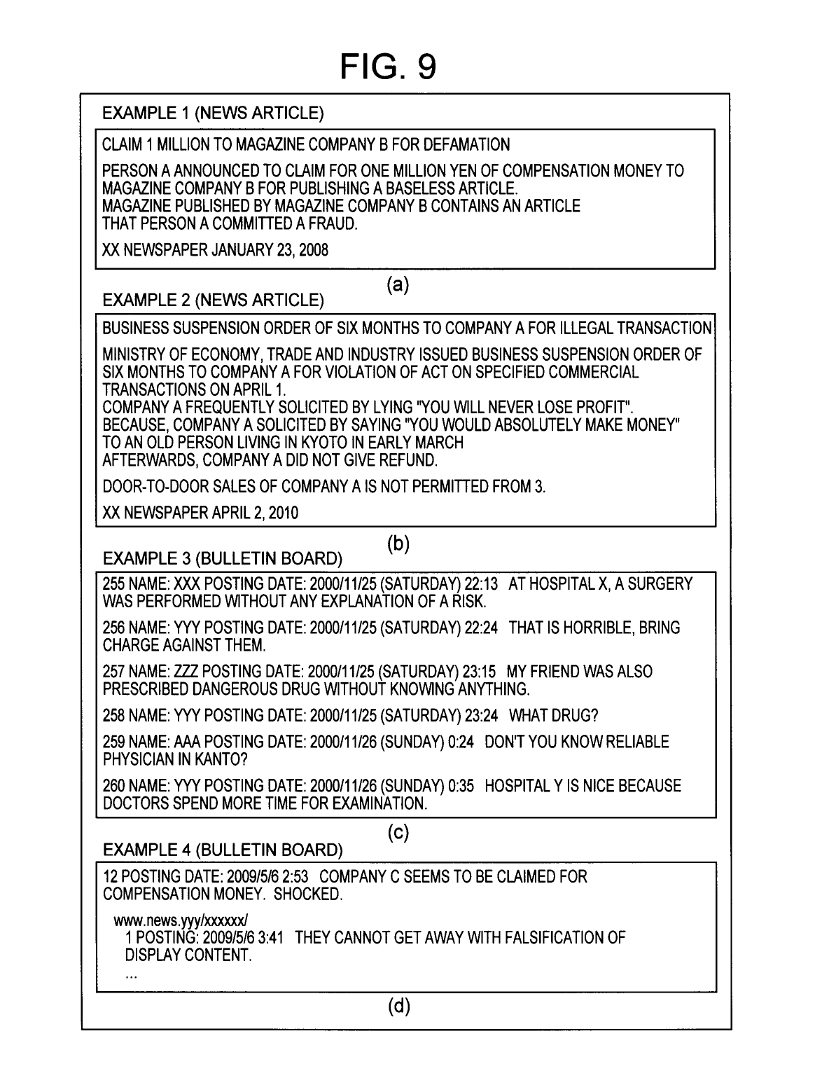

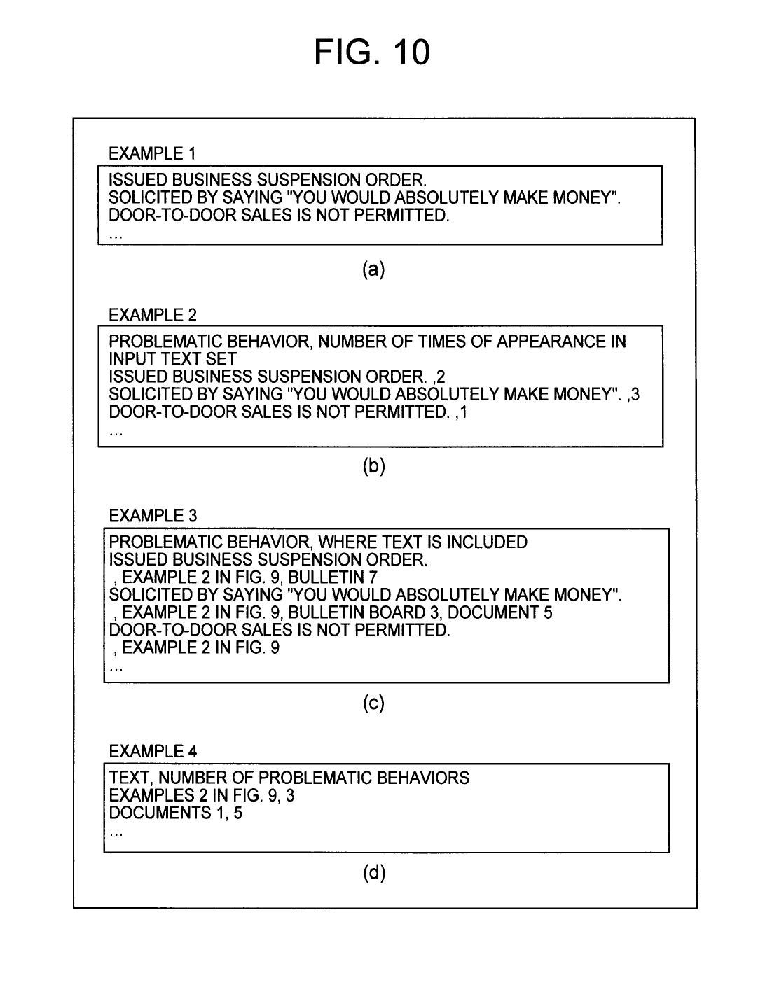

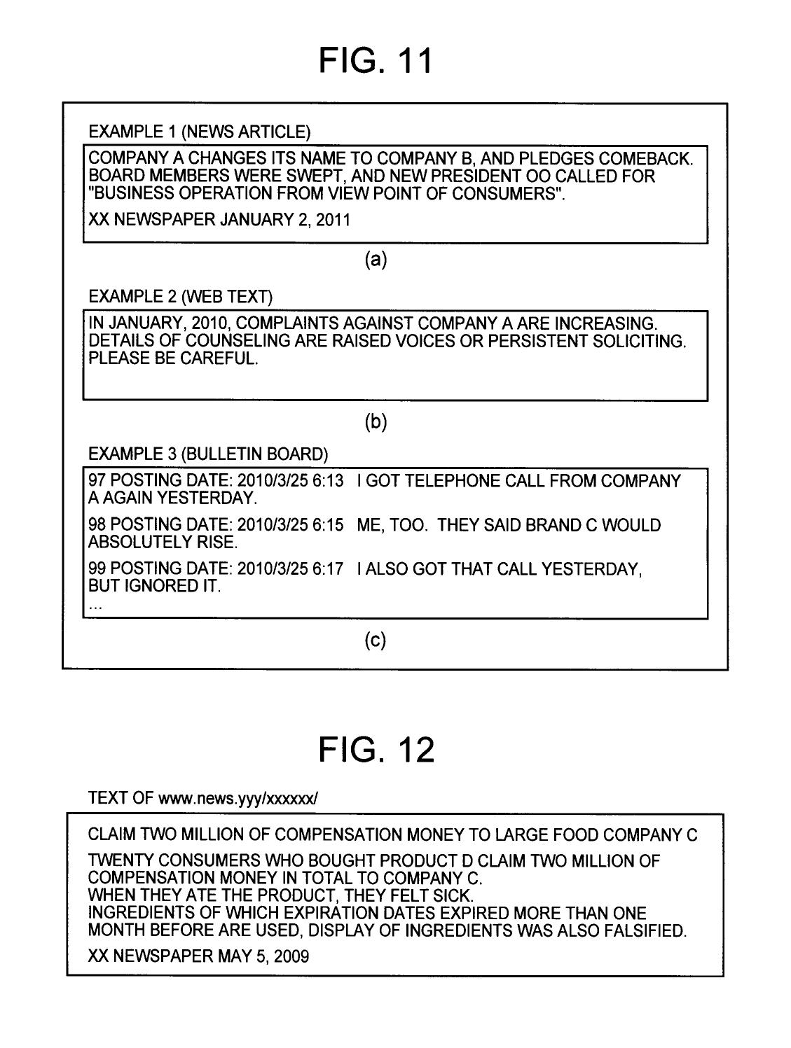

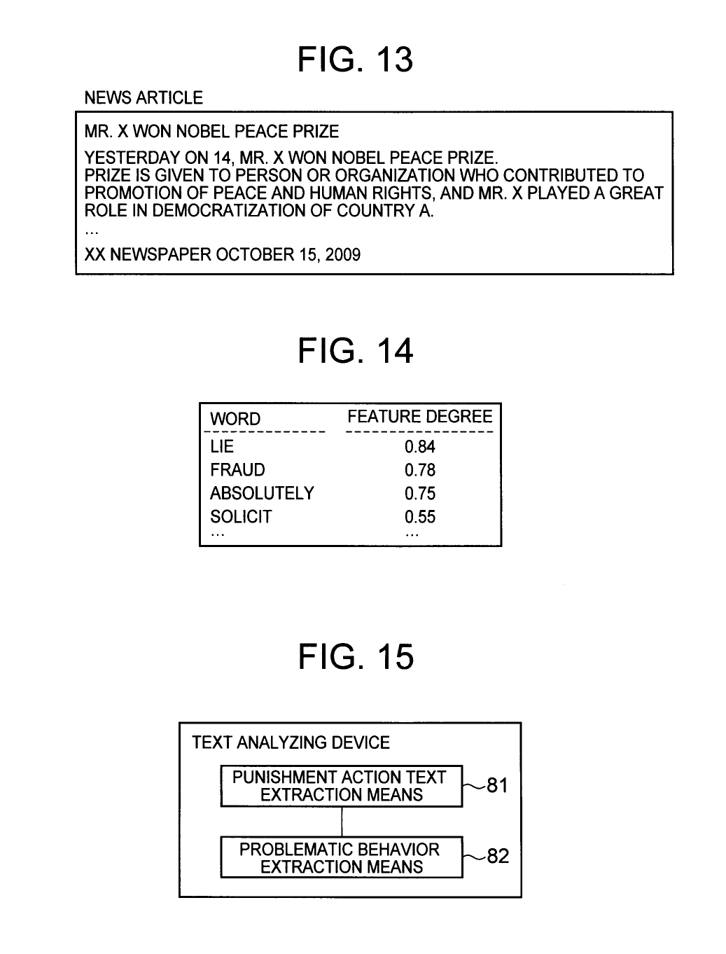

### BRIEF DESCRIPTION OF DRAWINGS

[FIG. 1] It depicts a block diagram illustrating a configuration example of a first exemplary embodiment of a text analyzing device according to the present invention.

[FIG. 2] It depicts a flowchart illustrating an operation example of the text analyzing device according to the first exemplary embodiment.

[FIG. 3] It depicts a block diagram illustrating a configuration example of a second exemplary embodiment of a text analyzing device according to the present invention.

[FIG. 4] It depicts a flowchart illustrating an operation example of the text analyzing device according to the second exemplary embodiment.

[FIG. 5] It depicts a block diagram illustrating a configuration example of a third exemplary embodiment of a text analyzing device according to the present invention.

[FIG. 6] It depicts a flowchart illustrating an operation example of the text analyzing device according to the third exemplary embodiment.

[FIG. 7] It depicts a block diagram illustrating a configuration example of a fourth exemplary embodiment of a text analyzing device according to the present invention.

[FIG. 8] It depicts a flowchart illustrating an operation example of the text analyzing device according to the fourth exemplary embodiment.

[FIG. 9] It depicts an explanatory view illustrating an example of a text including a punishable behavior.

[FIG. 10] It depicts an explanatory view illustrating an example of an output result.

[FIG. 11] It depicts an explanatory view illustrating an example of a text included in a search text set.

[FIG. 12] It depicts an explanatory view illustrating an example of a related text.

[FIG. 13] It depicts an explanatory view illustrating an example of a text included in a good behavior generation text set.

[FIG. 14] It depicts an explanatory view illustrating an example of a feature degree per word.

[FIG. 15] It depicts a block diagram illustrating an example of a minimum configuration of a text analyzing device according to the present invention.

### DESCRIPTION OF EMBODIMENTS

Hereinafter, exemplary embodiments of the present invention will be described with reference to the drawings.

### First Exemplary Embodiment

FIG. 1 is a block diagram illustrating a configuration example of a first exemplary embodiment of a text analyzing device according to the present invention. Further, FIG. 2 is a flowchart illustrating an operation example of the text analyzing device according to the present exemplary embodiment. The text analyzing device according to the present exemplary embodiment has a computer 10 which operates according to program control, and an output means 20. More specifically, the computer 10 is realized by, for example, a central processing unit, a processor and a device which performs data processing (referred to as a “data processing device”).

The computer 10 includes a punishment action text search means 11 and a pre-punishment action behavior extraction means 12.

The punishment action text search means 11 searches for description which relates to an action which indicates a punishment of a fraud or an illegal act, or an action for demanding the punishment (referred to a “punishment action” below), from a set 30 of a plurality of texts to be inputted (referred to an “input text set 30” below). Further, the punishment action text search means 11 extracts a text which describes a punishment action, from the input text set 30 (step A1). In addition, each text included in the input text set 30 may include an attribute of this text (for example, a news article or a text or a weblog released in a bulletin). This attribute is included in each text, so that the pre-punishment action behavior extraction means 12 described below can select a method of extracting a pre-punishment action behavior per attribute.

An action for demanding a punishment is, for example, an action such as accusation or prosecution. The punishment action text search means 11 may extract a text which describes a punishment action from the input text set 30 which includes, for example, a text created by, for example, a news article or a Consumer Generated Media (CGM).

The punishment action text search means 11 may extract a text which describes a punishment action from the input text set 30 based on a punishment action word list 40 which is a list of words which is created in advance and which indicates a punishment action. More specifically, the punishment action text search means 11 may extract a text by searching in the input text set 30 using a word included in the punishment action word list 40 as a search query condition. Words included in the punishment action word list are, for example, an arrest, a business improvement order, a business suspension order, a business transaction suspension order, accusation, prosecution, a claim for damage and a claim for compensation money.

Subsequently, the pre-punishment action behavior extraction means 12 extracts description related to a behavior (referred to as a “pre-punishment action behavior”) which is conducted before a punishment action and which is a cause of this punishment action, from the text extracted in step A1. That is, the pre-punishment action behavior extraction means 12 extracts description related to a pre-punishment action behavior which is conducted before the punishment action described in the text extracted by the punishment action text extraction means 11 and which is a cause of this conducted punishment action (step A2). The description related to a pre-punishment action behavior extracted in this way is description related to a behavior which is a cause of the conducted punishment action, and represents a problematic behavior corresponding to a fraud or an illegal act which is a target of the punishment action. Consequently, specifying description related to a pre-punishment action behavior is to specify description related to a problematic behavior.

Meanwhile, a behavior which is determined as a pre-punishment action behavior does not mean an action texted by a writer, and is a behavior described at each portion of the text. A time at which a behavior is conducted does not mean a time at which this behavior is texted by the writer, and means a time at which this behavior is conducted. Meanwhile, as described below, the time at which a behavior is texted by a writer may be approximated to a time of a behavior described at each portion of a text depending on cases.

The pre-action punishment action behavior extraction means 12 may take an advantage of that, for example, a text which describes the text extracted in step A1 relates to a punishment action. For example, the pre-punishment action behavior extraction means 12 may extract description related to a behavior conducted before a punishment action in the text as description related to a pre-punishment action behavior from the text extracted in step A1.

More specifically, the pre-punishment action behavior extraction means 12 determines a tense (the past tense, the present tense and the future tense) indicated by a portion which describes each behavior in the text extracted in step A1. Further, the pre-punishment action behavior extraction means 12 specifies a portion which includes a word in the punishment action word list 40 used in step A1 as the portion which describes the punishment action. Furthermore, the pre-punishment action behavior extraction means 12 extracts description related to a behavior described in a tense prior to the tense indicated by the portion which describes the punishment action as description related to a pre-punishment action behavior.

Still further, the pre-punishment action behavior extraction means 12 may use a date included in a portion which describes a punishment action. The pre-punishment action behavior extraction means 12 specifies, for example, a date existing in the same sentence in which a punishment action or each behavior is described, as a date of a description portion. When the date of the portion which describes the punishment action can be specified by analyzing the text extracted in step A1, the pre-punishment action behavior extraction means 12 may extract description related to a behavior of a portion prior to the date of the portion which describes the punishment action.

In addition, the pre-punishment action behavior extraction means 12 may specify the date by pinpointing the date. Further, the pre-punishment action behavior extraction means 12 may specify the date in a certain range such as the middle of April or April 10 to 15. Furthermore, when the entire range of the date of the portion which describes a given behavior is before the date of the portion which describes the punishment action, the pre-punishment action behavior extraction means 12 may determine that this behavior is a behavior conducted before the punishment action.

Furthermore, when, for example, the text extracted in step A1 is a text each portion of which is given the date as in a bulletin board, the pre-punishment action behavior extraction means 12 may specify the date given to the portion at which the punishment action or each behavior is described. Still further, the pre-punishment action behavior extraction means 12 may extract a behavior of a portion which describes the date prior to the date of the portion which describes the punishment action in the text extracted in step A1.

Moreover, the pre-punishment action behavior extraction means 12 may assume that, for example, the text extracted in step A1 is a text in which behavior are described in order of the conducted behavior, and extract a behavior which exists prior to the punishment action in the text extracted in step A1. This processing is effective processing when the text extracted in step A1 is a text which lists facts in chronological order.

Thus, the pre-punishment action behavior extraction means 12 may specify a date indicated by a portion which describes a punishment action in the text extracted in step A1, and extract description related to a behavior prior to this date as description related to a pre-punishment action behavior.

Further, the pre-punishment action behavior extraction means 12 may specify a behavior which is a cause of a punishment action from a behavior described in the text extracted in step A1 by analyzing the text extracted in step A1, and extract description related to this behavior as description related to a pre-punishment action behavior. The pre-punishment action behavior extraction means 12 may specify a portion which is a cause of a punishment action from the text extracted in step A1 using, for example, a technique of analyzing causation in the natural language processing field. Further, the pre-punishment action behavior extraction means 12 may extract a behavior which exists at the specified portion as a pre-punishment action behavior.

Furthermore, to specify a cause of a behavior, a causation pattern dictionary (not illustrated) which describes patterns which associate causes and results may be created in advance. In this case, the pre-punishment action behavior extraction means 12 performs pattern matching between each pattern of the causation pattern dictionary and the text extracted in step A1. Further, the pre-punishment action behavior extraction means 12 may extract as a pre-punishment action behavior a behavior described at a cause portion of a pattern the result of which matches with a punishment action. Examples of patterns which associate causes and results include “[cause] and therefore [result]”, “because of [cause], [result]”, “[cause]. Therefore, [result]” and “[result]. Because [cause]”.

Meanwhile, a text to be inputted is preferably a news article because a news report pattern is fixed to some degree and a news report pattern of a punishment action and a cause is easily set in advance. In this case, as news patterns which associate causes and results, “[cause] was allegedly conducted, and [punishment action] was taken” and “[cause] was conducted, and therefore [punishment action] was taken” may be set to a causation pattern dictionary. In this case, the pre-punishment action behavior extraction means 12 may extract a behavior described at a cause portion as a pre-punishment action behavior by matching a news article as the text extracted in step A1 and the news report pattern of the causation pattern dictionary.

Further, when the text to be inputted is a news article, the entire text is highly likely to be description related to a punishment action. Hence, the pre-punishment action behavior extraction means 12 may extract description related to a behavior targeting only at a news article in the text extracted in step A1. By so doing, it is possible to precisely extract description related to a given behavior which is a cause of a conducted punishment action.

Thus, the pre-punishment action behavior extraction means 12 may extract description related to a pre-punishment action behavior (that is, a problematic behavior) corresponding to this punishment action based on the causation in relation to the punishment action. More specifically, the pre-punishment action behavior extraction means 12 may extract description related to a pre-punishment action behavior leading to the punishment action based on a pattern (such as a pattern set to the causation pattern dictionary) which associates causation and a result. Further, the pre-punishment action behavior extraction means 12 may extract description related to a pre-punishment action behavior using a technique which is generally known in the natural language processing field and analyzes causation.

Furthermore, when a text to be inputted is a news article which reports a punishment action, it is highly likely that the punishment action is an event in the past and a behavior in the article is a behavior related to the punishment action. Hence, the pre-punishment action behavior extraction means 12 may target at only a news article as the text extracted in step A1. Further, the pre-punishment action behavior extraction means 12 may determine the tense of a description portion of each behavior in this text, and extract as a pre-punishment action behavior a behavior from which the current tense and the future tense are removed.

Furthermore, a behavior which is a cause of a punishment action is highly likely to be a behavior conducted by a target of the punishment action. Hence, the pre-punishment action behavior extraction means 12 may extract description related to a pre-punishment action behavior only in case of a behavior conducted by a target of a punishment action in description related to a behavior extracted by each of the above processing. By performing this processing, it is possible to improve precision of a problematic behavior to be extracted.

The pre-punishment action behavior extraction means 12 may specify a target of a punishment action or an agent of a behavior using, for example, a case structure analyzing technique in the natural language processing field. In this case, when the target or the agent is not clear, the pre-punishment action behavior extraction means 12 may specify the target or the agent by supplying necessary information by performing omission reference resolution. Further, the pre-punishment action behavior extraction means 12 only needs to extract a behavior the target of the specified punishment action and the agent of the behavior of which match as description related to the pre-punishment action behavior.

Furthermore, there is highly likely description related to a punishment action near the portion which describes the punishment action. Hence, the pre-punishment action behavior extraction means 12 first specifies a portion which describes the punishment action, from the text extracted in step A1. Further, the pre-punishment action behavior extraction means 12 may perform processing of extracting description related to the above pre-punishment action behavior targeting only at description of a behavior included in a vicinity portion in a range set in advance from the specified portion. Thus, by narrowing the range, it is possible to improve precision of a problematic behavior to be extracted. For example, the vicinity portion may be set as within n previous sentences, n subsequent sentences or n previous and subsequent sentences of a description portion of a punishment action or the same paragraph as a description portion of the punishment action. Meanwhile, n is a natural number.

Further, the text extracted in step A1 is likely to include a plurality of topics and portions which are not related to a punishment action. Hence, the pre-punishment action behavior extraction means 12 may perform processing of extracting description related to the above pre-punishment action behavior targeting only at a behavior included in a portion which indicates the same topic as the punishment action, from the text extracted in step A1.

More specifically, the pre-punishment action behavior extraction means 12 detects a topic boundary in the text according to a general topic division method in the natural language processing field. Further, the pre-punishment action behavior extraction means 12 divides the text into segments which are a group of the same topics based on this boundary. Furthermore, the pre-punishment action behavior extraction means 12 may perform processing of extracting description related to the above pre-punishment action behavior targeting only at a behavior which exists in the same segment as the description portion of the punishment action. Thus, by extracting a pre-punishment action behavior targeting at the same topic, it is possible to improve precision of a problematic behavior to be extracted.

In addition, a sentence, a segment, a phrase, a sentence syntactic tree, a subtree of the sentence syntactic tree, a pair of a verb and a segment, a verb case structure, a binary relationship between a subject and a verb and two co-occurring words in a sentence can be used as description units of a behavior. Further, the behavior may use not only an affirmative behavior such as “do” but also use a negative behavior of not conducting a behavior such as “do not conduct”.

Finally, the output means 20 outputs a set of descriptions related to the behavior extracted in step A2 (step A3). In this case, the output means 20 may also output statistical information such as the number of descriptions related to this behavior and included in the input text set. Further, the output means 20 may output description related to the extracted behavior together with a text which describes the behavior. Furthermore, the output means 20 may output description related to the behavior included in the text and extracted in step A2 per text of the input text set, and statistical information such as the number of included descriptions. Still further, the output means 20 may output only a behavior which more frequently appears in the input text set than a threshold set in advance in a set of descriptions related to the behavior extracted in step A2.

As described above, according to the present exemplary embodiment, the punishment action text search means 11 extracts a text which describes a punishment action, from the input text set 30. Further, description (that is, a pre-punishment action behavior) related to a behavior which is conducted before a punishment action described in the text extracted by the pre-punishment action behavior extraction means 12 and which is a cause of the conducted punishment action is extracted as description related to a problematic behavior. Consequently, it is possible to extract description related to the great amount of problematic behavior at low cost.

More specifically, according to the first exemplary embodiment, by performing processing in step A1 and step A2, it is possible to automatically extract description related to a problematic behavior which is conducted before a punishment action and which is a cause of a punishment action, from the input text set 30. Consequently, even when multiple texts are grouped as an input text set and description related to a great amount of problematic behavior is extracted, it is possible to suppress cost.

Further, according to the present exemplary embodiment, description related to a problematic behavior is extracted based on a punishment action. Consequently, even when, for example, the number of words included in the punishment action word list 40 obtained in step A1 is small, it is possible to extract description of a problematic behavior related to various frauds or illegal acts in processing in step A2.

### Second Exemplary Embodiment

FIG. 3 is a block diagram illustrating a configuration example of a second exemplary embodiment of a text analyzing device according to the present invention. Further, FIG. 4 is a flowchart illustrating an operation example of the text analyzing device according to the present exemplary embodiment. The text analyzing device according to the present exemplary embodiment has a computer 110 which operates according to program control, and an output means 120. More specifically, the computer 110 is realized by, for example, a central processing unit, a processor or a device which performs data processing (referred to as a “data processing device”).

The computer 110 includes a punishment action text search means 111 and a pre-punishment action behavior extraction means 112. Further, the pre-punishment action behavior extraction means 112 has a pre-punishment action text search means 113 and a behavior extraction means 114.

First, the punishment action text search means 111 searches for description related to a punishment action from an input text set 30. Further, the punishment action text search means 111 extracts a text which describes a punishment action, from the input text set 30 (step B1). In addition, an operation of the punishment action text search means 111 in step B1 is the same as an operation of a punishment action text search means 11 in step A1 according to the first exemplary embodiment, and therefore will not be described.

Subsequently, the pre-punishment action behavior extraction means 112 specifies a text including description related to a behavior conducted before the punishment action described in the text extracted in step B1. The pre-punishment action behavior extraction means 112 extracts from this text the description related to the behavior (that is, a pre-punishment action behavior) which is conducted before the punishment action and which is a cause of this punishment action (step B2 to step B3). Hereinafter, the operation of the pre-punishment action behavior extraction means 112 according to the present exemplary embodiment will be described.

First, the pre-punishment action text search means 113 extracts from a search text set 50 a text (referred to as a “pre-punishment action text” below) which describes a behavior before a punishment action in the text extracted in step B1 based on the search text set 50 which is a set of texts and the text extracted in step B1. Meanwhile, the search text set 50 is a set of texts which include descriptions related to a problematic behavior (that is, a pre-punishment action behavior). Further, the texts of the search text set 50 may not include descriptions related to a punishment action. In addition, the search text set 50 may be the same as the input text set 30 or a set of different texts given separately.

More specifically, the pre-punishment action text search means 113 first specifies a date indicated by a portion which describes a punishment action in the text extracted in step B1. The pre-punishment action text search means 113 specifies a date indicated by a portion which describes a punishment action using, for example, a method of specifying a date by the pre-punishment action behavior extraction means 12 according to the first exemplary embodiment.

Further, when the text extracted in step B1 is a news article which reports the punishment action, the pre-punishment action text search means 113 may specify a news report day of a news article as a date of a portion which describes the punishment action, using a little time shift between the punishment action and the report day of the news article.

Furthermore, the pre-punishment action text search means 113 extracts from the search text set 50 a text (that is, a pre-punishment action text) which describes a behavior conducted on a date before the date indicated by the portion which describes the punishment action (step B2). The pre-punishment action text search means 113 may specify a text including a date portion before the date indicated by the portion which describes the punishment action, from, for example, the search text set 50, and extract this text as a pre-punishment action text.

Further, generally, when a date traces back more from a date at which a punishment action is conducted, a text is less likely to be associated with a fraud or an illegal act which is a target of a punishment action. Hence, the pre-punishment action text search means 113 may limit an extraction target pre-punishment action text to a text which describes a closer date than a value set in advance. As this value, a relative degree of passage from a date of the portion which describes the punishment action like “within n days from a date of a portion which describes a punishment action”. In addition, n is a natural number. Further, to this value, a date such as “subsequent to XXXX (year) X (month) X (date)” may be specified directly.

Subsequently, the behavior extraction means 114 extracts description related to a behavior before the punishment action is taken, as description related to a pre-punishment action behavior from the pre-punishment action text extracted in step B2 (step B3). The behavior extraction means 114 may extract a behavior from which a behavior of the future tense is removed, among behavior described at a portion of the date prior to the portion which describes the punishment action from, for example, the pre-punishment action text. The behavior extraction means 114 may specify a date indicated by a portion which describes each behavior using the same method as the method of specifying the date indicated by the portion which describes the punishment action. Further, the behavior extraction means 114 may extract description related to a pre-punishment action behavior using the same method as the method of extracting description related to a pre-punishment action in the pre-punishment action extraction means 12 in step A2 according to the first exemplary embodiment.

Furthermore, a behavior which is a cause of a punishment action is highly likely to be a behavior conducted by a target of the punishment action. Hence, the behavior extraction means 114 may extract description related to a pre-punishment action behavior only in case of descriptions related to behavior extracted by the above processing and related to behavior conducted by a target of a punishment action. By performing this processing, it is possible to improve precision of a problematic behavior to be extracted.

Finally, the output means 120 outputs a set of descriptions related to the behavior extracted in step B3 (step B4). In addition, the method of outputting a set of descriptions related to a behavior from the output means 120 is the same as the output method from an output means 20 in step A3 according to the first exemplary embodiment, and therefore will not be described.

As described above, according to the present exemplary embodiment, the pre-punishment action search means 113 specifies a date indicated by a portion which describes a punishment action from the text extracted from the input text set 30, and extracts the text which describes the behavior conducted before the date specified from the search text set 50. Further, the behavior extraction means 114 extracts description related to a behavior before a punishment action is taken, as description related to a problematic behavior from the extracted text.

That is, in the present exemplary embodiment, description related to a problematic behavior is extracted from the pre-punishment action text extracted in step B2. Consequently, in addition to the effect according to the first exemplary embodiment, it is also possible to extract description related to a problematic behavior from a text which does not include description related to a punishment action by specifying a date of the punishment action.

### Third Exemplary Embodiment

FIG. 5 is a block diagram illustrating a configuration example of a third exemplary embodiment of a text analyzing device according to the present invention. Further, FIG. 6 is a flowchart illustrating an operation example of the text analyzing device according to the present exemplary embodiment. The text analyzing device according to the present exemplary embodiment has a computer 210 which operates according to program control, and an output means 220. More specifically, the computer 210 is realized by, for example, a central processing unit, a processor or a device which performs data processing (referred to as a “data processing device”).

The computer 210 includes a punishment action text search means 211 and a pre-punishment action behavior extraction means 212. Further, the pre-punishment action behavior extraction means 212 has a related extraction means 213 and a behavior extraction means 214.

First, the punishment action text search means 211 searches for description related to a punishment action from an input text set 30. Further, the punishment action text search means 211 extracts a text which describes a punishment action, from the input text set 30 (step C1). In addition, an operation of the punishment action text search means 211 in step C1 is the same as an operation of a punishment action text search means 11 in step A1 according to the first exemplary embodiment, and therefore will not be described.

Subsequently, the pre-punishment action behavior extraction means 212 extracts description related to a behavior (that is, a pre-punishment action behavior) which is a cause of a punishment action in the text extracted in C1, from a text (referred to as a “related text” below) related to the text extracted in step C1 (step C2 to step C3). Hereinafter, the operation of the pre-punishment action behavior extraction means 212 according to the present exemplary embodiment will be described.

First, the related text extraction means 213 extracts a related text of the text extracted in step C1 from a related text extraction text set 60 based on the related text extraction text set 60 which is a set of texts and the text extracted in step C1 (step C2). Meanwhile, the related text extraction text set 60 is a set of texts which include descriptions related to a problematic behavior (that is, a pre-punishment action behavior). Further, the texts of the related text extraction text set 60 may not include descriptions related to a punishment action. In addition, the related text extraction text set 60 may be the same as the input text set 30 or a set of different texts given separately.

When, for example, the text extracted in step C1 is a web page, and a link is provided in this web page, the related text extraction means 213 may extract a text of this link destination as a related text. Further, when specifying a link provided in the text extracted in step C1, from the text of the related text extraction text set 60, the related text extraction means 213 may extract the text of this link source as a related text. Meanwhile, the link is information which indicates a position of another document.

When, for example, the text extracted in step C1 is a news article published in a web page, a link is, for example, a link to a related news article. Further, when, for example, the text extracted in step C1 is a text written in response to given information or a text written in response to given information such as CGM which is typically a weblog or a bulletin board, a link is, for example, a link to this information source.

Furthermore, the related text extraction means 213 may extract a text having a higher similarity to the text extracted in step C1 as a related text. In addition, a method of extracting a text having a higher similarity will be described.

Subsequently, the behavior extraction means 214 extracts description related to a behavior before the punishment action in the text extracted in step C1 is taken, as description related to a pre-punishment action behavior from the related text extracted in step C2 (step C3). More specifically, the behavior extraction means 214 specifies a date indicated by a portion which describes a punishment action in the text extracted in step C1. The behavior extraction means 214 only needs to use a method of specifying a date in a pre-punishment action text search means 113 in step B2 according to the second exemplary embodiment as a method of specifying a date indicated by a portion which describes a punishment action.

Further, the behavior extraction means 214 may extract a behavior from which a behavior of the future tense is removed, among behavior described at a portion of the date prior to the portion which describes the punishment action from, for example, the related text. In this case, the behavior extraction means 214 may extract a behavior using the same method as the method of extracting description related to a pre-punishment action behavior in the behavior extraction means 114 in step B3 according to the second exemplary embodiment.

Further, when the related text extracted in step C2 is a text of a link destination provided from the text extracted in step C1, the behavior extraction means 214 may use a fact that the text of the link destination is created prior to the text of the link source. More specifically, the behavior extraction means 214 may determine a tense per description portion of each behavior in the related text, and extract description related to a behavior from which the behavior of the future tense is removed from each behavior in the related text. Further, the behavior extraction means 214 may extract description related to a pre-punishment action behavior using the same method as the method of extracting description related to a pre-punishment action in the pre-punishment action extraction means 12 in step A2 according to the first exemplary embodiment.

Furthermore, a behavior which is a cause of a punishment action is highly likely to be a behavior conducted by a target of the punishment action. Hence, the behavior extraction means 214 may extract description related to a pre-punishment action behavior only in case of descriptions related to behavior extracted by the above processing and related to behavior conducted by a target of a punishment action. By performing this processing, it is possible to improve precision of a problematic behavior to be extracted.

Finally, the output means 220 outputs a set of descriptions related to the behavior extracted in step C3 (step C4). In addition, the method of outputting a set of descriptions related to a behavior from the output means 220 is the same as the output method from an output means 20 in step A3 according to the first exemplary embodiment, and therefore will not be described.

As described above, according to the present exemplary embodiment, the related text extraction means 213 extracts as a related text from the related text extraction text set 60 a text having a high similarity to the text extracted from the input text set 30, a text specified from a link provided in the text extracted from the input text set 30 or the text which describes as a link destination the text extracted from the input text set 30. Further, the behavior extraction means 214 extracts description related to a behavior before a punishment action is taken, as description related to a problematic behavior from the extracted related text.

That is, in the present exemplary embodiment, description related to a problematic behavior is extracted from the related text extracted in step C2. Consequently, in addition to the effect according to the first exemplary embodiment, it is possible to extract description related to a problematic behavior from a related text related to the text extracted in step C1 even when description related to a punishment action is not included in a related text.

### Fourth Exemplary Embodiment

FIG. 7 is a block diagram illustrating a configuration example of a fourth exemplary embodiment of a text analyzing device according to the present invention. Further, FIG. 8 is a flowchart illustrating an operation example of the text analyzing device according to the present exemplary embodiment. The text analyzing device according to the present exemplary embodiment has a computer 310 which operates according to program control, and an output means 320. More specifically, the computer 310 is realized by, for example, a central processing unit, a processor or a device which performs data processing (referred to as a “data processing device”).

The computer 310 has a punishment action text search means 311, a pre-punishment action behavior extraction means 312, a good behavior generation means 313 and a good behavior comparison means 314.

Further, the punishment action text search means 311 extracts a text which describes a punishment action, from the input text set 30 (step D1). In addition, the method of extracting a text which describes a punishment action in a punishment action text search means 311 is the same as an operation of the punishment action text search means 11 according to the first exemplary embodiment, and therefore will not be described.

Subsequently, the pre-punishment action behavior extraction means 312 extracts description related to a pre-punishment action behavior from the text extracted by the punishment action text search means 311 (step D2). The pre-punishment action behavior extraction means 312 may extract description related to a pre-punishment action behavior using the same method as that of the pre-punishment action behavior extraction means 12 in step A2 according to the first exemplary embodiment. Further, the pre-punishment action behavior extraction means 312 may extract description related to a pre-punishment action behavior using the same method as that of the pre-punishment action behavior extraction means 112 in step B2 to step B3 according to the second exemplary embodiment. Furthermore, the pre-punishment action behavior extraction means 312 may extract description related to a pre-punishment action behavior using the same method as that of the pre-punishment action behavior extraction means 212 in step C1 and step C2 according to third first exemplary embodiment.

Subsequently, the good behavior generation means 313 extracts description related to a good behavior from a good behavior generation text set 70 which is a set of texts for generating a set of behavior (referred to as “good behavior” below) irrespective of a fraud and an illegal act, and generates a set of good behavior (step D3). The good behavior generation text set 70 is a set of texts including a good behavior as described above. The good behavior generation text set 70 may be the same as the input text set 30 or a set of different texts given separately.

When, for example, a set of texts irrespective of a fraud or an illegal act is provided as the good behavior generation text set 70, the good behavior generation means 313 may extract description related to a behavior from this text and generate a set of the extracted behavior as a set of good behavior. The set of texts irrespective of a fraud or an illegal act is, for example, a set of texts which describe news articles which report good news.

Further, the good behavior generation means 313 may generate as a set of good behavior a set of behavior the agents of which are people (referred to as “good doer” below) who do not conduct a fraud or an illegal act. For example, by setting a set of good doers in advance, the good behavior generation means 313 may also extract description related to a behavior the agent of which is included in the set of good doers, from each behavior described in a text included in the good behavior generation text set 70, and generate the set of extracted behavior and the set of good behavior. A good doer may be set to, for example, a person who cracks down on a fraud or an illegal act.

Further, the good behavior generation means 313 may specify a target of the punishment action extracted in step D1, and set targets other than the specified target as a good doer. That is, description related to a behavior from a behavior the agent of which is the target of the punishment action is removed may be extracted as a behavior the agent of which is a good doer from each behavior described in the text included in the good behavior generation text set 70. Further, the good behavior generation means 313 may set the set of extracted behavior as the set of good doers. The good behavior generation means 313 may specify the target of the punishment action or the agent of the behavior using the same method as the method (for example, the case structure analysis technique) of specifying the target of the punishment action or the agent of the behavior in the pre-punishment action behavior extraction means 12 in step A2 according to the first exemplary embodiment.

Further, the good behavior generation means 313 may assume that, after the punishment action is taken, there is not a behavior related to a fraud or an illegal action which is the target of this punishment action, and generate the set of behavior conducted after the punishment action extracted in step D1 as the set of good behavior.

The good behavior generation means 313 specifies a date indicated by a portion which describes a punishment action in the text extracted in step D1. Further, the good behavior generation means 313 specifies a text created after a date indicated by a portion which describes the punishment action, from the text in the good behavior generation text set 70. The good behavior generation means 313 may specify a text using the same method as the method of extracting a pre-punishment action text in the pre-punishment action behavior search means 113 in step B2 according to the second exemplary embodiment. Further, the good behavior generation means 313 determines the tense of each behavior described in the specified text. Furthermore, the good behavior generation means 313 extracts description related to a behavior other than a behavior of the past tense from description related to each behavior, and generates the set of extracted behavior as the set of good behavior.

Still further, the good behavior generation means 313 determines the date of each portion of the text, and specifies a portion corresponding to a date after a date indicated by a portion which describes a punishment action. Moreover, the good behavior generation means 313 may extract a behavior other than a behavior of the past tense from the behavior described in the specified portion, and generate the set of extracted behavior as the set of good behavior. In addition, the good behavior generation means 313 may use the same method as the method of specifying the date in the pre-punishment action text search means 113 in step B2 according to the second exemplary embodiment as a method of determining the date of each portion.

Further, in step D2, the good behavior generation means 313 may generate as a set of good behavior the set of behavior which are not extracted as pre-punishment action behavior from the text extracted by the pre-punishment action text search means 311.

Furthermore, it is assumed that, after the punishment action is taken, the person who is the target of this punishment action does not conduct a fraud or an illegal act. Hence, the good behavior generation means 313 may generate as the set of good behavior the set of only behavior the agent of which is the target of the punishment action extracted in step D1 among behavior conducted after the punishment action extracted in step D1. In addition, the good behavior generation means 313 only needs to specify a behavior conducted after a punishment action, specify the agent of a behavior or specify a target of a punishment action using the above method.

Subsequently, when receiving an input of the set of the pre-punishment action behavior generated in step D2 and a set of good behavior generated in step D3, the good behavior comparison means 314 compares the sets of good behavior and extracts a set of behavior which frequently appears in the set of pre-punishment action behavior (step D4). More specifically, the good behavior comparison means 314 calculates a feature degree which indicates a degree of a feature of the pre-punishment action behavior upon comparison of each element of the pre-punishment action behavior and a good behavior set using the general mining method. Further, the good behavior comparing means 314 specifies a characteristic behavior of the pre-punishment action behavior from each behavior included in the set of pre-punishment action behavior.

Finally, the output means 320 outputs a set of descriptions related to the behavior extracted in step D4 (step D5). In addition, the method of outputting a set of descriptions related to a behavior from the output means 320 is the same as the output method from an output means 20 in step A3 according to the first exemplary embodiment, and therefore will not be described.

As described above, according to the present exemplary embodiment, the good behavior generation means 313 generates a set of good behavior from the good behavior generation text set 70. Further, the good behavior comparison means 314 extracts from a set of problematic behavior a set of behavior which more frequently appear in the set of problematic actions extracted by the pre-punishment action extraction means 312 than the set of good behavior. That is, in the present exemplary embodiment, a behavior corresponding to an inappropriate good behavior as a problematic behavior is removed in the pre-punishment action behavior in step D4. Consequently, it is possible to precisely extract a problematic behavior.

### Example 1

Although the present invention will be described based on a specific example, the scope of the present invention is not limited to the content described below. The text analyzing device according to Example 1 corresponds to a text analyzing device according to the first exemplary embodiment. Further, in the following description, an input text set 30 is text set on a web page, and a punishment action word list 40 includes three words of “business suspension order”, “prosecution” and “claim for compensation money”.

More specifically, the punishment action text search means 11 searches in the input text set 30 using a word included in the punishment action word list 40 as a search query condition. Further, the punishment action text search means 11 extracts a text which describes a word included in the punishment action word list 40, from the input text set 30 (step A1).

FIG. 9 is an explanatory view illustrating an example of a text including a punishment action. “Example 1” illustrated in FIG. 9(a) and “Example 4” illustrated in FIG. 9(d) are texts which describe the word “claim for compensation money”. Further, “Example 2” illustrated in FIG. 9(b) is a text which describes a word “business suspension order”. Furthermore, “Example 3” illustrated in FIG. 9(c) is a text which describes a word “bring charge”.

Subsequently, the pre-punishment action behavior extraction means 12 extracts description related to a pre-punishment action behavior, from the text extracted in step A1. For example, the pre-punishment action behavior extraction means 12 may extract description related to a behavior conducted before a punishment action described in the text as description related to a pre-punishment action behavior from the text extracted in step A1.

Meanwhile, a behavior which is determined as a pre-punishment action behavior does not mean an action texted by a writer, and is a behavior described at each portion of the text. A time at which a behavior is conducted does not mean a time at which this behavior is texted by the writer, and means a time at which this behavior is conducted.

For example, a 257th post of “Example 3” illustrated in FIG. 9(c) is specified as a behavior ““name ZZZ” posted at 23:15 on Nov. 25, 2000 that “my friend was also prescribed dangerous drug without knowing anything””. Meanwhile, the target to be specified by the pre-punishment action behavior extraction means 12 is not the above behavior, and is a behavior “my friend was also prescribed dangerous drug without knowing anything”. Further, the data at which the behavior is conducted is not 23:15 on Nov. 25, 2000 at which the 257th post is made but a time at which a dangerous drug is prescribed (that is, before 23:15 on Nov. 25, 2000). Meanwhile, as described below, the time at which a behavior is texted by a writer may be approximated to a time of a behavior described at each portion of a text depending on cases.

A case that a pair of a verb and a segment related to this verb is used as description units will be described. Meanwhile, description units of behavior are not limited to a pair of a verb and a segment related to this verb. The method which is capable of specifying a behavior may handle behavior in other units.

The pre-punishment action behavior extraction means 12 first determines a tense indicated by a portion which describes each behavior. The pre-punishment action behavior extraction means 12 may determine the tense according to, for example, a method disclosed in PLT 2, and determine the tense using another method which is generally known. Further, the pre-punishment action behavior extraction means 12 extracts a behavior of a portion described in a tense prior to the tense of the portion which describes the punishment action. In addition, when the tense is determined in the following description, it is possible to use these methods.

Hereinafter, the method of determining the tense targeting at “Example 1” illustrated in FIG. 9(a) will be described. The pre-punishment action behavior extraction means 12 first specifies a portion (that is, a portion which includes a word given as a search query condition in step A1) which describes the punishment action, from the text extracted in step A1. In this case, the portion “claim for compensation money” disclosed in the first sentence in the second paragraph is specified. Further, the pre-punishment action behavior extraction means 12 determines the tense of this portion. In this case, the portion which describes the punishment action is determined to be in the current tense.

Further, the pre-punishment action behavior extraction means 12 extracts a behavior of the portion described in the past tense which is the tense prior to the current tense among behavior included in “Example 1” illustrated in FIG. 9(a). In this case, behavior such as “person A committed a fraud”, “magazine contains an article that person A committed a fraud” and “magazine published by magazine company B contains an article” are extracted from the third sentence.

Further, the pre-punishment action behavior extraction means 12 may also extract description related to a behavior of a portion prior to the date of the portion which describes the punishment action among each behavior included in the text extracted in step A1 as description related to a pre-punishment action behavior.

In “Example 2” illustrated in FIG. 9(b), the first sentence in the second paragraph is specified as a portion which describes a punishment action. The pre-punishment action behavior extraction means 12 extracts a date expression in this sentence, and specifies the date of the portion which describes the punishment action as April 1. Similarly, the pre-punishment action behavior extraction means 12 can specify the date of the behavior described in the third sentence in the second paragraph as the early part of March and specify the date of the behavior described in the third paragraph as (April) 3. Further, the pre-punishment action behavior extraction means 12 compares these dates. In this case, the pre-punishment action behavior extraction means 12 can determine the behavior prior to the date of the portion which describes the punishment action as the behavior described in the third sentence in the second paragraph. Hence, the pre-punishment action behavior extraction means 12 extracts description related to a behavior in this sentence the description related to a pre-punishment action behavior.

Further, when, for example, the date is assigned to each portion of the text extracted in step A1, the pre-punishment action behavior extraction means 12 may extract description related to a behavior of a portion which describes a date prior to the date of the portion which describes the punishment action from the text extracted in step A1.

When, for example, the text extracted in step A1 is “Example 3” illustrated in FIG. 9(c), the punishment action is specified as the 256th post. Hence, the pre-punishment action behavior extraction means 12 may specify the date of the portion which describes the punishment action as “22:24 on Nov. 25, 2000”. Further, the pre-punishment action behavior extraction means 12 may extract description of the portion (that is, the behavior in the 255th post) prior to this date as description related to a pre-punishment action behavior.

Furthermore, the pre-punishment action behavior extraction means 12 may assume that, for example, the text extracted in step A1 is a text in which behavior are described in order of the conducted behavior, and extract description related to a behavior which exists prior to the punishment action in the text extracted in step A1. When, for example, the text extracted in step A1 is “Example 3” illustrated in FIG. 9(c), the punishment action is specified as the 256th post. Further, the pre-punishment action behavior extraction means 12 may extract the behavior in the 255th post which exists prior to this post as description related to a pre-punishment action behavior.

Furthermore, the pre-punishment action behavior extraction means 12 may specify a behavior which is a cause of a punishment action from a behavior in the text extracted in step A1 by analyzing the text extracted in step A1, and extract description related to this behavior as description related to a pre-punishment action behavior. The pre-punishment action behavior extraction means 12 may specify a portion which is a cause of a punishment action from the text extracted in step A1 using, for example, a technique of analyzing causation in NPL 1. Further, the pre-punishment action behavior extraction means 12 may extract description related to a behavior which exists at the specified portion as description related to a pre-punishment action behavior.

In case of, for example, “Example 1” illustrated in FIG. 9(a), the case of the punishment action of “claim for compensation money” is specified as a portion “for publishing a baseless article”. Hence, the pre-punishment action behavior extraction means 12 extracts “publishing a baseless article” which is a behavior included in this portion as description related to a pre-punishment action behavior.

Further, the pre-punishment action behavior extraction means 12 may extract description related to a pre-punishment action behavior using a causation pattern dictionary. For example, “[result]. Because [cause]” is described in the causation pattern dictionary. Further, “Example 2” illustrated in FIG. 9(b) in step A1 is extracted. In this case, the pre-punishment action extraction means 12 first compares each pattern described in the causation pattern dictionary and content of “Example 2” illustrated in FIG. 9(b), and specifies a pattern the result of which matches the punishment action. In this case, the first sentence and the second sentence in the second paragraph match the pattern of “[result]. Because [cause]”. Further, the pre-punishment action behavior extraction means 12 extracts a behavior in “solicited by lying “you will never lose money”” corresponding to the cause portion as description related to the pre-punishment action behavior.

Furthermore, when a text to be inputted is a news article, a news report pattern is fixed to some degree and a news report pattern of a punishment action and a cause is easily set in advance. Hence, the news report pattern of the punishment action and this cause is described in the causation pattern dictionary. Hence, the pre-punishment action behavior extraction means 12 may perform processing of extracting description related to a pre-punishment action behavior targeting only at a news article as the text extracted in step A1. In the example illustrated in FIG. 9, “Example 1” and “Example 2” which indicate news articles are processing targets.

Hence, the pre-punishment action behavior extraction means 12 extracts a behavior targeting only at a news article as the text extracted in step A1. In the example illustrated in FIG. 9, “Example 1” and “Example 2” which indicate news articles are processing targets.

Further, the pre-punishment action behavior extraction means 12 may target at only a news article as the text extracted in step A1. Furthermore, the pre-punishment action behavior extraction means 12 may determine the tense of a description portion of each behavior in this text, and extract as description related to a pre-punishment action behavior description related to a behavior from which the current tense and the future tense are removed. In the example illustrated in FIG. 9, “Example 1” and “Example 2” which indicate news articles are processing targets. In this case, for example, a behavior of a portion from which the third paragraph of the future tense is removed is extracted from “Example 2” illustrated in FIG. 9(b).

Hence, the pre-punishment action behavior extraction means 12 may extract description related to a pre-punishment action behavior only in case of a behavior conducted by a target of a punishment action in description extracted by each of the above processing. In this case, the pre-punishment action behavior extraction means 12 first specifies a target of a punishment action. The pre-punishment action behavior extraction means 12 analyzes a case structure of a verb of the punishment action using, for example, a case structure analyzing technique in the natural language processing field. Further, the pre-punishment action behavior extraction means 12 may specify the portion corresponding to an object case as a target of the punishment action. Furthermore, the pre-punishment action behavior extraction means 12 may also specify a portion corresponding to “wo case”, “ni case” or “he case” as a target of the punishment action. In case of, for example, “Example 2” illustrated in FIG. 9(b), the pre-punishment action behavior extraction means 12 can specify “to company A” as the target of the punishment action even if any one of the above two methods is used.

Further, the pre-punishment action behavior extraction means 12 extracts a behavior the agent of which is the target of the punishment action. The pre-punishment action behavior extraction means 12 analyzes a case structure of each behavior using, for example, a case structure analyzing technique in the natural language processing field, and extracts a behavior an agent case of which is the target of the punishable operation. Further, the pre-punishment action behavior extraction means 12 may extract behavior “ga case” of which is the target of the punishable operation using, for example, a case structure analyzing technique in the natural language processing field.

In a case of, for example, “Example 2” illustrated in FIG. 9(b), the pre-punishment action behavior extraction means 12 supplements an omission element using the omission reference analyzing technique upon case structure analysis. Further, the pre-punishment action behavior extraction means 12 extracts behavior in the second to fourth sentences in the second paragraph and in the third paragraph as behavior the agent of which is “company A” which is the target of the punishment action, from behavior to which the omission elements are supplemented.

Thus, by extracting description related to a behavior of the target of the punishment action, it is possible to remove behavior which relate to a punishment action and are inappropriate as problematic behavior such as behavior on a party which cracks down on an illegal act. In a case of, for example, “Example 2” illustrated in FIG. 9(b), it is possible to remove description related to a behavior the agent of which is Ministry of Economy, Trade and Industry in the first sentence in the second paragraph from description related to a pre-punishment action behavior. Consequently, precision of a problematic behavior to be extracted improves.

Further, the pre-punishment action behavior extraction means 12 may perform processing of extracting description related to the above pre-punishment action behavior targeting only at a behavior included in a vicinity portion in a range set in advance from the portion which describes the punishment action.

The target range may be, for example, one sentence before and after the portion which describes a punishment action. In a case of, for example, “Example 3” illustrated in FIG. 9(c), the description portion of the punishment action is the 256th post. Therefore, the target range is from the 255th to 257th posts. Further, the target range may be the same paragraph as a portion which describes a punishment action. In a case of, for example, “Example 2” illustrated in FIG. 9(b), a behavior in the second paragraph is an extraction target.

Thus, by limiting the target range, it is possible to improve precision of a problematic behavior to be extracted. It is possible to remove, for example, posts of which content is irrelevant to hospital X (more specifically, the 259th and 260th posts) which is distant from the 256th post in “Example 3” illustrated in FIG. 9(c).

Hence, the pre-punishment action behavior extraction means 12 may perform processing of extracting description related to the above pre-punishment action behavior targeting only at a behavior included in a portion which indicates the same topic as the punishment action, from the text extracted in step A1. More specifically, the pre-punishment action behavior extraction means 12 detects a topic boundary in the text extracted in step A1 using, for example, the general topic division method in the natural language processing field or a method disclosed in PLT 3. Further, the pre-punishment action behavior extraction means 12 divides the text into segments which are a group of the same topics based on this boundary. Furthermore, the pre-punishment action behavior extraction means 12 may perform processing of extracting description related to the above pre-punishment action behavior targeting only at a behavior which exists in the same segment as the description portion of the punishment action.

In a case of, for example, “Example 3” illustrated in FIG. 9(c), a topic boundary is detected between the 258th post and the 259 post. Hence, the pre-punishment action behavior extraction means 12 may set behavior in the 255th to 258 posts which are the same topic portions as the description portion (256th) of the punishment action as extraction targets. In this case, it is possible to remove behavior of the 259 and 260 posts which are topics irrelevant to hospital X. Thus, by extracting description related to a pre-punishment action behavior targeting at the same topic, it is possible to improve precision of a problematic behavior to be extracted.

Finally, the output means 20 outputs a set of descriptions related to the behavior extracted in step A2 (step A3). FIG. 10 is an explanatory view illustrating an example of an output result. FIG. 10(a) illustrates an example where three behavior of “issued business suspension order.” “solicited by saying “you would absolutely make money”” and “door-to-door sales is not permitted” are extracted as descriptions related to pre-punishment action behavior in step A2.

In this case, when outputting a set of descriptions related to a language, the output means 20 may also output statistical information such as the number of descriptions related to this behavior and included in the input text set. FIG. 10(b) illustrates an example that “issued business suspension order.” appears twice in the input text set as descriptions related to a problematic behavior (pre-punishment action behavior).

Further, the output means 20 may output description related to the extracted behavior together with a text which describes the behavior. FIG. 10(c) illustrates an example that “issued business suspension order.” is included in the text specified in Example 2 in FIG. 9 and a bulletin board 7 (not illustrated in FIG. 9).

Further, the output means 20 may also output statistical information such as the number of described behavior and extracted in step A2. FIG. 10(d) illustrates an example that three problematic behavior are included in the text illustrated in Example 2 in FIG. 9.

Still further, the output means 20 may output only description which more frequently appears in the input text set than a threshold set in advance in a set of descriptions related to the behavior extracted in step A2. When, for example, a threshold is set to 2 in “Example 2” illustrated in FIG. 10(b), the output means 20 may output “issued business suspension order.” and “solicited by saying “you would absolutely make money”” as description related to a problematic behavior.

As described above, the text analyzing device performs processing in step A1 and step A2 in the present example, so that it is possible to automatically extract description related to a problematic behavior which is a cause of the conducted punishment action illustrated in FIG. 10 from the input text set. Consequently, even when multiple texts are grouped as an input text set and description related to a great amount of problematic behavior is extracted, it is possible to suppress cost.

Further, according to the present example, description related to a problematic behavior is extracted based on a punishment action. Consequently, even when, for example, the number of words included in the punishment action word list 40 obtained in step A1 is small, the pre-punishment action behavior extraction means 12 can extract description related to a problematic behavior related to various frauds or illegal acts in step A2. It is possible to extract description related to behavior of two types of frauds such as defamation from “Example 1” illustrated in FIG. 9(a) and falsification of display content from “Example 4” illustrated in FIG. 9(d) from one punishment action of “claim for compensation money”.

### Example 2

Next, Example 2 will be described. A text analyzing device according to Example 2 corresponds to a text analyzing device according to the second exemplary embodiment.

First, the punishment action text search means 111 searches for description related to a punishment action from an input text set 30. Further, the punishment action text search means 111 extracts a text which describes a punishment action, from the input text set 30 (step B1). In addition, an operation of the punishment action text search means 111 in step B1 is the same as an operation of the punishment action text search means 11 in step A1 according Example 1, and therefore will not be described.

Subsequently, the pre-punishment action behavior extraction means 112 specifies a text including description related to a behavior conducted before the punishment action described in the text extracted in step B1. The pre-punishment action behavior extraction means 112 extracts from this text the description related to the behavior (that is, a pre-punishment action behavior) which is conducted before the punishment action and which is a cause of this punishment action (step B2 to step B3). Hereinafter, the operation of the pre-punishment action behavior extraction means 112 according to the present example will be described.

First, the pre-punishment action text search means 113 extracts a pre-punishment action text corresponding to the text extracted in step B1, from the search text set 50. FIG. 11 is an explanatory view illustrating an example of a text included in the search text set 50. In the present example, an operation of including texts illustrated in FIGS. 11(a) to 11(c) in the search text set 50, and searching for a pre-punishment action text corresponding to “Example 2” illustrated in FIG. 9(b) will be described.

The pre-punishment action text search means 113 first specifies a date indicated by a portion which describes a punishment action included in “Example 2” in FIG. 9(b). The pre-punishment action text search means 113 specifies as April 1 a date indicated by a portion which describes a punishment action of the business suspension order using, for example, a method of specifying a date by the pre-punishment action behavior extraction means 12 in step A2 according to the first exemplary embodiment. Further, the text illustrated in FIG. 9(b) is a news article. Hence, the pre-punishment action text search means 113 may assume the date of the portion which describes a report day of the news article as the punishment action. That is, the pre-punishment action text search means 113 may specify the date of the portion which describes a punishment action of a business suspension order as Apr. 2, 2010.

Further, the pre-punishment action text search means 113 extracts from the search text set 50 a text which describes a behavior conducted on a date before the date of the portion which describes the punishment action (step B2). For example, from the text illustrated in FIG. 9(b), the date of the portion which describes the punishment action is specified as Apr. 1 (or Apr. 2, 2010). In this case, the pre-punishment action text search means 113 may extract a text including a date portion before April 1 which is the portion which describes the punishment action, from the search text set 50.

For example, it is possible to determine that an event in January 2010 is described in “Example 2” illustrated in FIG. 11(b). Hence, the pre-punishment action text search means 113 extracts this text. Similarly, it is possible to determine that an event on Mar. 25, 2010 is described in “Example 3” illustrated in FIG. 11(c). This date comes before the date of the punishment action. Hence, the pre-punishment action text search means 113 extracts this text. Similarly, it is possible to determine that an event on Jan. 2, 2011 is described in “Example 1” illustrated in FIG. 11(a). Hence, the pre-punishment action text search means 113 does not extract this text as a pre-punishment action text.

Further, the pre-punishment action text search means 113 may limit an extraction target pre-punishment action text to a text which describes a closer date than a value set in advance. When, for example, “a date within one month from the date of a punishment action is an extraction target” is set, the pre-punishment action text search means 113 extracts a text in “Example 3” illustrated in FIG. 11(c) of the texts illustrated in FIGS. 11(a) to 11(c) as a pre-punishment action text.

Subsequently, the behavior extraction means 114 extracts description related to a behavior before the punishment action is taken, as description related to a pre-punishment action behavior from the pre-punishment action text extracted in step B2 (step B3). For example, the text in “Example 2” which describes a business suspension order and which is illustrated in FIG. 9(b) is extracted as the text which describes the punishment action in step B1, and “Example 2” and “Example 3” illustrated in FIGS. 11(b) and 11(c) are extracted. In this case, the behavior extraction means 114 extracts description related to a behavior before Apr. 1 (or Apr. 2, 2010) from “Example 2” and “Example 3” illustrated in FIGS. 11(b) and 11(c). The behavior extraction means 114 may extract description related to a behavior from which a behavior of the future tense is removed, among behavior described at a portion of the date prior to the portion which describes the punishment action from, for example, the pre-punishment action text.

In a case of, for example, “Example 2” illustrated in FIG. 11(b), the date in the first sentence is January 2010, and comes before the date of the portion which describes the punishment action. Further, the first sentence is in the current tense, and therefore a behavior “complaints against company A are increasing.” is extracted. In a case of “Example 3” illustrated in FIG. 11(C), dates of 97th to 99th posts are all Mar. 25, 2010, and come before the date of the portion which describes the punishment action. Hence, the behavior extraction means 114 extracts “I got telephone call again yesterday”, “I got telephone call from company A”, “I got telephone call”, “got telephone call yesterday” and “I ignored the call (it)” among behavior included in the 97th to 99th posts from which behavior of the future tense are removed.

Hence, the behavior extraction means 114 may extract description related to a pre-punishment action behavior only in a case of descriptions related to behavior extracted by the above processing and related to behavior conducted by a target of a punishment action. Further, the behavior extraction means 114 may extract a pre-punishment action behavior using the same method as the method of extracting a pre-punishment action by narrowing down targets in the pre-punishment action extraction means 12 in step A2 according to the first exemplary embodiment. In this case, “they said brand c would absolutely rise” is extracted from “Example 3” illustrated in FIG. 11(c). By performing this processing, it is possible to remove an inappropriate behavior as a problematic behavior and, consequently, improve precision of a problematic behavior to be extracted.

Finally, the output means 120 outputs a set of descriptions related to the behavior extracted in step B3 (step B4). The output means 120 outputs, for example, a behavior including “they said brand C would absolutely rise”. In addition, the method of outputting a set of descriptions related to a behavior from the output means 120 is the same as the output method from an output means 20 in step A3 according to the first exemplary embodiment, and therefore will not be described.

That is, in the present example, description related to a problematic behavior is extracted from the pre-punishment action text extracted in step B2. Consequently, it is also possible to extract description related to a problematic behavior from a text which does not include description related to a punishment action if a date of the punishment action can be specified.

For example, description related to a punishment action is not included in “Example 2” and “Example 3” illustrated in FIGS. 11(b) and 11(c). Meanwhile, these texts include descriptions related to a problematic behavior such as “they said brand C would absolutely rise”. Consequently, in addition to the effect according to the first example, it is also possible to extract description related to a problematic behavior from a text which does not include description related to a punishment action.

### Example 3

Next, Example 3 will be described. The text analyzing device according to Example 3 corresponds to a text analyzing device according to the third exemplary embodiment.

First, the punishment action text search means 211 searches for description related to a punishment action from an input text set 30. Further, the punishment action text search means 211 extracts a text which describes a punishment action, from the input text set 30 (step C1). In addition, an operation of the punishment action text search means 211 in step C1 is the same as an operation of a punishment action text search means 11 in step A1 according to the first exemplary embodiment, and therefore will not be described.

Subsequently, the pre-punishment action behavior extraction means 212 extracts description related to a behavior (that is, a pre-punishment action behavior) which is a cause of a punishment action in the text extracted in C1, from the related text extracted in step C1 (step C2 to step C3). Hereinafter, the operation of the pre-punishment action behavior extraction means 212 according to the present exemplary embodiment will be described.

First, the related text extraction means 213 extracts a related text of the text extracted in step C1 from a related text extraction text set 60 based on the related text extraction text set 60 and the text extracted in step C1 (step C2). In addition, in the present example, the related text extraction text set 60 is a text set on a web page.

The related text extraction means 213 may specify, for example, a text of a link destination as a related text. FIG. 12 is an explanatory view illustrating an example of a related text. The related text extraction means 213 extracts a text specified as “www.news.yyy/xxxxxx/” illustrated in FIG. 12 as a related text from “Example 4” illustrated in FIG. 9(d). Further, when specifying a link provided in the text extracted in step C1, from the text of the related text extraction text set 60, the related text extraction means 213 may extract the text of this link source as a related text.

Furthermore, the related text extraction means 213 may extract a text having a higher similarity to the text extracted in step C1 as a related text. More specifically, the related text extraction means 213 converts the text extracted in step C1 and each text in the related text extraction text set into a unit vector which represents an element of an order appears in a morpheme corresponding to the order by assuming the order as the morpheme. In this case, the related text extraction means 213 only needs to represent as 1 a value in case that a corresponding morpheme appears, and represents as 0 a value in a case that the morpheme does not appear. Further, the related text extraction means 213 calculates a cosine similarity between unit vectors as the similarity between texts, and extracts a text having the calculated cosine similarity higher than a threshold manually set in advance. In addition, the method of extracting the text having the high similarity is not limited to the above method.

Subsequently, the behavior extraction means 214 extracts description related to a behavior before the punishment action in the text extracted in step C1 is taken, as description related to a pre-punishment action behavior from the related text extracted in step C2 (step C3). For example, the date of the portion which describes the punishment action is specified as May 6, 2009 from “Example 4” illustrated in FIG. 9(d). In this case, the behavior extraction means 214 extracts description related to a behavior described in the date portion before May 6, 2009 and a behavior from which a behavior of the future tense is removed. In this case, the behavior extraction means 214 only needs to use a method of specifying a date in a pre-punishment action text search means 113 in step B2 according to the second exemplary embodiment as a method of specifying a date indicated by a portion which describes a punishment action. In this case, the report day of the news text illustrated in FIG. 12 is May 5, 2009, so that the behavior extraction means 214 can specify the date of the portion which describes a behavior included in the related text illustrated in FIG. 12 May 5, 2009. In this case, a behavior from which a behavior of the future tense is removed such as “felt sick”, “ingredients of which expiration dates expired more than one month before are used” or “display of ingredients was also falsified”.

Further, when the related text extracted in step C2 is a text of a link destination provided from the text extracted in step C1, the behavior extraction means 214 may use a fact that the text of the link destination is created prior to the text of the link source. More specifically, the behavior extraction means 214 may determine a tense per description portion of each behavior in the related text, and extract description related to a behavior from which the behavior of the future tense is removed from each behavior in the related text. In this case, the behavior extraction means 214 extracts description related to a behavior from which a behavior of the future tense is removed among behavior included in the related text illustrated in FIG. 12.

Hence, the behavior extraction means 214 may extract description related to a pre-punishment action behavior only among behavior conducted by a target of a punishment action among behavior extracted by the above processing. The behavior extraction means 214 may extract description related to a pre-punishment action behavior using the same method as the method of extracting description related to a pre-punishment action by narrowing down the pre-punishment action extraction means 12 in the pre-punishment action extraction means 12 in step A2 according to the first exemplary embodiment. In this case, “ingredients of which expiration dates expired more than one month before are used” or “display of ingredients was also falsified” are extracted from the related text illustrated in FIG. 12. By performing this processing, it is possible to remove an inappropriate behavior as a problematic behavior and, consequently, improve precision of a problematic behavior to be extracted.

Finally, the output means 220 outputs a set of descriptions related to the behavior extracted in step C3 (step C4). The output means 220 outputs behavior including “ingredients of which expiration dates expired more than one month before are used” or “display of ingredients was also falsified”. In addition, the method of outputting a set of descriptions related to a behavior from the output means 220 is the same as the output method from an output means 20 in step A3 according to the first exemplary embodiment, and therefore will not be described.

That is, in the present example, description related to a problematic behavior is extracted from the related text extracted in step C2. Consequently, it is possible to extract description related to a problematic behavior from a related text related to the text extracted in step C1 even when description related to a punishment action is not included in a related text.

For example, description related to a punishment action is not included in the related text illustrated in FIG. 12. Meanwhile, these texts include descriptions related to problematic behavior such as “use a food material of which expiration date expired more than one month” and “display content of a good material was also falsified”. Consequently, in addition to the effect according to the first example, it is also possible to extract description related to a problematic behavior from a text which does not include description related to a punishment action.

### Example 4

Next, Example 4 will be described. The text analyzing device according to Example 4 corresponds to a text analyzing device according to Example 4.

First, the punishment action text search means 311 searches for description related to a punishment action from an input text set 30. Further, the punishment action text search means 311 extracts a text which describes a punishment action, from the input text set 30 (step D1). In addition, an operation of the punishment action text search means 311 in step D1 is the same as an operation of a punishment action text search means 11 in step A1 according to the first exemplary embodiment, and therefore will not be described.

Subsequently, the pre-punishment action behavior extraction means 312 extracts description related to a pre-punishment action behavior from the text extracted by the punishment action text search means 311 (step D2). The pre-punishment action behavior extraction means 312 may extract description related to a pre-punishment action behavior using the same method as that of the pre-punishment action behavior extraction means 12 in step A2 according to the first exemplary embodiment. Further, the pre-punishment action behavior extraction means 312 may extract description related to a pre-punishment action behavior using the same method as that of the pre-punishment action behavior extraction means 112 in step B2 to step B3 according to the second exemplary embodiment. Furthermore, the pre-punishment action behavior extraction means 312 may extract description related to a pre-punishment action behavior using the same method as that of the pre-punishment action behavior extraction means 212 in step C1 and step C2 according to the third exemplary embodiment.

Subsequently, the good behavior generation means 313 extracts description related to a good behavior from a good behavior generation text set 70 and generates a set of good behavior (step D3). FIG. 13 is an explanatory view illustrating an example of a text included in a good behavior generation text set 70. In an example illustrated in FIG. 13, the good behavior generation text set 70 is a set of news articles which report good news. The good behavior generation means 313 may extract description related to a behavior included in the good behavior generation text set 70 illustrated in FIG. 13, and generate the description related to this behavior as a set of good behavior.

Further, the good behavior generation means 313 may generate as a set of good behavior a set of behavior the agents of which are good doers. For example, by setting a set of good doers in advance, the good behavior generation means 313 may also extract description related to a behavior the agent of which is included in the set of good doers, from each behavior described in a text included in the good behavior generation text set 70, and generate the set of extracted behavior as the set of good behavior. The good doers are, for example, authorities such as the police department, police stations and Ministry of Economy, Trade and Industry. Further, when the text set illustrated in FIG. 9 is given, the good behavior generation means 313 extracts a behavior “Ministry of Economy, Trade and Industry issued business suspension order” of which agent is Ministry of Economy, Trade and Industry as a good behavior from the text in “Example 2” illustrated in FIG. 9(b).

Furthermore, the good behavior generation means 313 may specify a punishment action target extracted in step D1, and extract description related to a behavior from which behavior of which agents are the punishment action targets are removed from each behavior of the text included in the good behavior generation text set 70.

For example, the input text set 30 and the good behavior generation text set 70 are both sets of texts illustrated in FIG. 9. In this case, the good behavior generation means 313 specifies magazine company B from “Example 1” illustrated in FIG. 9(a), company A from “Example 2” illustrated in FIG. 9(b), hospital X from “Example 3” illustrated in FIG. 9(c) and company C from “Example 4” illustrated in FIG. 9(d) as targets of punishment actions.

Further, the good behavior generation means 313 may extract a behavior other than that of the target of the punishment action among each behavior included in the “Example 1” to “Example 4” illustrated in FIG. 9 as description related to a good behavior. The good behavior generation means 313 extracts behavior such as “person A announced” and “person A claims for 1 million yen of compensation money” as description related to a good behavior from “Example 2” illustrated in FIG. 9(a).

In addition, the good behavior generation means 313 may specify the target of the punishment action or the agent of the behavior using the same method as the method (for example, the case structure analysis technique) of specifying the target of the punishment action or the agent of the behavior in the pre-punishment action behavior extraction means 12 in step A2 according to the first exemplary embodiment.

Further, the good behavior generation means 313 may generate as the set of good behavior the set of behavior conducted after the punishment action extracted in step D1. For example, the input text set 30 and the good behavior generation text set 70 are both sets of texts illustrated in FIG. 9. In this case, the good behavior generation means 313 can specify the date of the portion which describes the punishment action from “Example 2” illustrated in FIG. 9(b) as Apr. 1, 2010.

Further, the good behavior generation means 313 extracts behavior other than behavior in the past tense from behavior described in the text included in the good behavior generation text set 70 to the date portion subsequent to Apr. 1, 2010, and generates the set of the extracted behavior as a set of the good behavior. The good behavior generation means 313 extracts a behavior such as “door-to-door sales is not permitted” as description related to a good behavior, from “Example 2” illustrated in FIG. 9(b).

Further, for example, the date given to the portion which describes the punishment action included in “Example 3” illustrated in FIG. 9(c) is “2000/11/25 23:15”. Hence, the good behavior generation means 313 may extract behavior other than behavior in the past tense from behavior of the 257th to 260th posts which are portions to which a date after this date is given. From these posts, for example, “spend more time for examination” is extracted as description related to a good behavior.

Further, in step D2, the good behavior generation means 313 may generate as a set of good behavior the set of behavior which are not extracted as pre-punishment action behavior from the text extracted by the pre-punishment action text search means 311. When, for example, the input text set 30 is a set of texts illustrated in FIG. 9, the good behavior generation means 313 extract as description related to a good behavior the description such as “door-to-door sales is not permitted” which is not extracted as a pre-punishment action behavior from “Example 2” illustrated in FIG. 9(b).

Hence, the good behavior generation means 313 may generate as the set of good behavior the set of only behavior the agent of which is the target of the punishment action extracted in step D1 among behavior conducted after the punishment action extracted in step D1. For example, the input text set 30 and the good behavior generation text set 70 are both sets of texts illustrated in FIG. 9. In this case, the good behavior generation means 313 specifies “door-to-door sales is not permitted” as a behavior conducted after the punishment action extracted in step D1. The agent of this behavior is company A, and a target of a punishment action. Hence, the good behavior generation means 313 extracts the behavior as description related to a good behavior. If the agent is not company A, this behavior is not extracted as description related to a good behavior.

Subsequently, when receiving an input of the set of the pre-punishment action behavior generated in step D2 and a set of good behavior generated in step D3, the good behavior comparison means 314 compares the sets of good behavior and extracts a set of behavior which frequently appears in the set of pre-punishment action behavior (step D4). In this case, the good behavior comparison means 314 may use a technique (see NPL 2) of specifying elements such as characteristic words and idioms in a text of a predetermined category. The good behavior comparison means 314 can calculate the feature degree of a characteristic word in a set of pre-punishment action behavior and the pre-punishment action behavior by using the technique disclosed in NPL 2. FIG. 14 is an explanatory view illustrating an example of a feature degree per word.

Next, the good behavior comparison means 314 calculates the feature degree of each behavior included in this set of pre-punishment action behavior from the feature degree per word. This feature degree can be calculated by, for example, “the number of elements in feature degree/behavior given to elements in the feature degree of a behavior=a behavior”. Meanwhile, in case of an example illustrated in FIG. 14, elements correspond to words.

For example, a result of morpheme analysis of a behavior “solicited by lying (uso wo itte kanyuu shita)” is “uso/wo/it/te/kanyuu/shi/ta”. In this case, the number of words is specified as 7. In this case, the good behavior comparison means 314 calculates the feature degree of this behavior (0.84+0.55)/7=0.25.

Further, the good behavior comparison means 314 extracts a behavior having the feature degree of a behavior higher than a threshold manually set in advance, and generates the set of extracted behavior as a set of good behavior. When, for example, the threshold is set to 0.2, this “solicited by lying” is extracted as description related to a good behavior. Meanwhile, a feature degree of a behavior “Ministry of Economy, Trade and Industry issued business suspension order” is calculated as 0 in case of an example illustrated in FIG. 14. Hence, this behavior is not extracted as description related to a good behavior.

Finally, the output means 320 outputs a set of descriptions related to the behavior extracted in step D4 (step D5). For example, in the above example, the output means 320 outputs “solicited by lying”, and does not output “Ministry of Economy, Trade and Industry issued business suspension order”. In addition, the method of outputting a set of behavior from the output means 320 is the same as the output method from an output means 20 in step A3 according to the first exemplary embodiment, and therefore will not be described.

That is, in the present exemplary embodiment, a behavior corresponding to an inappropriate good behavior as a problematic behavior is removed from the pre-punishment action behavior in step D4. Consequently, it is possible to precisely extract a problematic behavior. Consequently, in the present example, in addition to the effect according to the first example, it is possible to remove “Ministry of Economy, Trade and Industry issued business suspension order” which is an inappropriate behavior as a problematic behavior from description related to a problematic behavior.

Next, an example of a minimum configuration of the present invention will be described. FIG. 15 is a block diagram illustrating an example of a minimum configuration of a text analyzing device according to the present invention. A text analyzing device (for example, the computer 10) according to the present invention includes: a punishment action text extraction means 81 (for example, the punishment action text extraction means 11) which extracts a text which describes a punishment action which is an action which indicates a punishment of a fraud or an illegal act, or an action for demanding the punishment, from an input text set (for example, the input text set 30) which is a set of a plurality of texts to be inputted; and a problematic behavior extraction means 82 (for example, the problematic behavior extraction means 12) which extracts description related to a problematic behavior (for example, a pre-punishment action behavior) which is a cause of the conducted punishment action taken before the punishment action described in the text extracted by the punishment action text extraction means 81.

According to this configuration, it is possible to extract description related to the great amount of problematic behavior at low cost.

In addition, although part or entirety of the above exemplary embodiments are described as in the following supplementary notes, the exemplary embodiments are by no means limited to the following.

(Supplementary note 1) A text analyzing device includes: a punishment action text extraction means which extracts a text which describes a punishment action which is an action which indicates a punishment of a fraud or an illegal act, or an action for demanding the punishment, from an input text set which is a set of a plurality of texts to be inputted; and a problematic behavior extraction means which extracts description related to a problematic behavior which is a cause of the punishment action taken before the punishment action described in the text extracted by the punishment action text extraction means.

(Supplementary note 2) In the text analyzing device described in Supplementary note 1, the punishment action text extraction means extracts the text which describes the punishment action, from the input text set which includes a text created from a news article or a consumer generated medium.

(Supplementary note 3) In the text analyzing device described in Supplementary note 1 or 2, the problematic behavior extraction means specifies a date indicated by a portion which describes the punishment action, from the text extracted by the punishment action text extraction means, and extracts description related to a behavior before the date as description related to the problematic behavior from the text.

(Supplementary note 4) In the text analyzing device described in Supplementary note 1 or 2, the problematic behavior extraction means extracts the description related to the problematic behavior corresponding to the punishment action based on causation in relation to the punishment action described in the text extracted by the punishment action text extraction means.

(Supplementary note 5) In the text analyzing device described in Supplementary note 1 or 2, the problematic behavior extraction means includes: a text extraction means which specifies a date indicated by a portion which describes the punishment action, from the text extracted by the punishment action text extraction means, and extracts a text which describes a behavior conducted before the date, from a problematic behavior containing text which is a set of texts including the description related to the problematic behavior; and a behavior extraction means which extracts description related to the behavior before the punishment action is taken, as the description related to the problematic behavior from the text extracted by the text extraction means.

(Supplementary note 6) In the text analyzing device described in Supplementary note 1 or 2, the problematic behavior extraction means includes: a related text extraction means which extracts as a related text from a problematic behavior containing text which is a set of texts including the description related to the problematic behavior a text having high similarity to the text extracted by the punishment action text extraction means, a text specified from a link which indicates position information of another document described in the text extracted by the punishment action text extraction means or a text which describes the link indicating the text extracted by the punishment action text extraction means; and a behavior extraction means which extracts description related to the behavior before the punishment action is taken, as the description related to the problematic behavior from the related text extracted by the related text extraction means.

(Supplementary note 7) The text analyzing device according to any one of Supplementary notes 1 to 6 further includes: a good behavior generation means which generates a set of good behavior from a good behavior text set which is a set of texts including description related to a good behavior which is a behavior irrelevant to a fraud and an illegal act; and a good behavior extraction means which extracts a behavior which frequently appears in a set of problematic behavior extracted by the problematic behavior extraction means compared to the set of the good behavior, from the set of the problematic behavior.

(Supplementary note 8) In the text analyzing device described in any one of Supplementary notes 1 to 7, the problematic behavior extraction means extracts description related to a behavior conducted by a target of the punishment action from the description related to the extracted problematic behavior.

(Supplementary note 9) In the text analyzing device described in Supplementary note 7, the good behavior generation means generates as the set of good behavior a set of good behavior conducted after the punishment action included in the text extracted by the punishment action text extracting means.

(Supplementary note 10) In the text analyzing device described in Supplementary note 7 or 9, the good behavior generation means specifies a good doer which is a person who does not commit a fraud or an illegal action, and generates a set of behavior an agent of which is the good doer as the set of good behavior.

(Supplementary note 11) A problematic behavior extracting method includes: extracting a text which describes a punishment action which is an action which indicates a punishment of a fraud or an illegal act, or an action for demanding the punishment, from an input text set which is a set of a plurality of texts to be inputted; and extracting description related to a problematic behavior which is a cause of the punishment action taken before the punishment action described in the extracted text.

(Supplementary note 12) The problematic behavior extracting method described in Supplementary note 11, includes extracting the text which describes the punishment action, from the input text set which includes a text created from a news article or a consumer generated medium.

(Supplementary note 13) A problematic behavior extraction program causes a computer to execute: punishment action text extraction processing of extracting a text which describes a punishment action which is an action which indicates a punishment of a fraud or an illegal act, or an action for demanding the punishment, from an input text set which is a set of a plurality of texts to be inputted; and problematic behavior extraction processing of extracting description related to a problematic behavior which is a cause of the punishment action taken before the punishment action described in the text extracted by the punishment action text extraction means.

(Supplementary note 14) In the problematic behavior extraction program described in Supplementary note 13, in the punishment action text extraction processing, the text which describes the punishment action is extracted from the input text set which includes a text created from a news article or a consumer generated medium.

Although the present invention has been described above with reference to the exemplary embodiments and examples, the present invention is by no means limited to the above exemplary embodiments and examples. The configurations and the details of the present invention can be variously changed within a scope of the present invention which one of ordinary skill in art can understand.

This application claims priority to Japanese Patent Application No. 2011-070202 filed on Mar. 28, 2011, the entire contents of which are incorporated by reference herein.

### INDUSTRIAL APPLICABILITY

It is possible to automatically extract a problematic behavior which led to a punishment action, from a text by using a text analyzing device according to the present invention. Consequently, the present invention provides an effect when people in the investigation of a fraud or an illegal act extract a problematic behavior which led to a punishment action of an investigation target from a test on a web page or a text such as newspaper or magazines. Further, the present invention also provides an effect when a user refers to a problematic behavior which led to a punishment action of a company of a person to determine whether or not the company or the person is good.

Furthermore, it is possible to use a problematic behavior extracted by the present invention as learning data of another technique. By, for example, applying data created by the present invention to a device disclosed in Patent Document 1, it is possible to detect a problematic behavior which will lead to a punishment action even if the punishment action is not currently taken. Consequently, the present invention provides an effect when a company or an organization monitors whether or not a person or an organization related to this company or organization conducts a problematic behavior, in a text on a web page. The present invention also provides an effect when a person or an organization in charge of cracking down on a fraud or an illegal act or warn or advise on these acts monitors whether or not there is a problematic behavior which is a warning or advise target on a web page.

### REFERENCE SIGNS LIST

10,110,210,310 Computer
11,111,211,311 Punishment action text search means
12,112,212,312 Pre-punishment action behavior extraction means
113 Pre-punishment action text search means
114,214 Behavior extraction means
213 Related text extraction means
313 Good behavior generation means
314 Good behavior comparison means
20,120,220,320 Output means
30 Input text set
40 Punishment action word list
50 Search text set
60 Related text extraction text set
70 Good behavior generation text set

What is claimed is:

1.-10. (canceled)

11. A text analyzing device comprising:
a punishment action text extraction unit which extracts a text which describes a punishment action which is an action which indicates a punishment of a fraud or an illegal act, or an action for demanding the punishment, from an input text set which is a set of a plurality of texts to be inputted; and
a problematic behavior extraction unit which extracts description related to a problematic behavior which is a cause of the punishment action taken before the punishment action described in the text extracted by the punishment action text extraction unit.

12. The text analyzing device according to claim 11, wherein the punishment action text extraction unit extracts the text which describes the punishment action, from the input text set which includes a text created from a news article or a consumer generated medium.

13. The text analyzing device according to claim 11, wherein the problematic behavior extraction unit specifies a date indicated by a portion which describes the punishment action, from the text extracted by the punishment action text extraction unit, and extracts description related to a behavior before the date as description related to the problematic behavior from the text.

14. The text analyzing device according to claim 11, wherein the problematic behavior extraction unit extracts the description related to the problematic behavior corresponding to the punishment action based on causation in relation to the punishment action described in the text extracted by the punishment action text extraction unit.

15. The text analyzing device according to claim 11, wherein the problematic behavior extraction unit comprising:
a text extraction unit which specifies a date indicated by a portion which describes the punishment action, from the text extracted by the punishment action text extraction unit, and extracts a text which describes a behavior conducted before the date, from a problematic behavior containing text which is a set of texts including the description related to the problematic behavior; and
a behavior extraction unit which extracts description related to the behavior before the punishment action is taken, as the description related to the problematic behavior from the text extracted by the text extraction unit.

16. The text analyzing device according to claim 11, wherein the problematic behavior extraction unit comprising:
a related text extraction unit which extracts as a related text from a problematic behavior containing text which is a set of texts including the description related to the problematic behavior a text comprising high similarity to the text extracted by the punishment action text extraction unit, a text specified from a link which indicates position information of another document described in the text extracted by the punishment action text extraction unit or a text which describes the link indicating the text extracted by the punishment action text extraction unit; and
a behavior extraction unit which extracts description related to the behavior before the punishment action is taken, as the description related to the problematic behavior from the related text extracted by the related text extraction unit.

17. A text analyzing device according to claim 11, further comprising;
a good behavior generation unit which generates a set of good behavior from a good behavior text set which is a set of texts including description related to a good behavior which is a behavior irrelevant to a fraud and an illegal act; and
a good behavior extraction unit which extracts a behavior which frequently appears in a set of problematic behavior extracted by the problematic behavior extraction unit compared to the set of the good behavior, from the set of the problematic behavior.

18. The text analyzing device according to claim 11, wherein the problematic behavior extraction unit extracts description related to a behavior conducted by a target of the punishment action from the description related to the extracted problematic behavior.

19. A problematic behavior extraction method comprising:
extracting a text which describes a punishment action which is an action which indicates a punishment of a fraud or an illegal act, or an action for demanding the punishment, from an input text set which is a set of a plurality of texts to be inputted; and
extracting description related to a problematic behavior which is a cause of the punishment action taken before the punishment action described in the extracted text.

20. A non-transitory computer readable information recording medium storing a problematic behavior extraction program that, when executed by a processor, performs a method for:
extracting a text which describes a punishment action which is an action which indicates a punishment of a fraud or an illegal act, or an action for demanding the punishment, from an input text set which is a set of a plurality of texts to be inputted; and
extracting description related to a problematic behavior which is a cause of the punishment action taken before the punishment action described in the extracted text.
